(19) United States
(12) Patent Application Publication
(10) Pub. No.: US 2018/0158084 A1
(43) Pub. Date: Jun. 7, 2018

(54) SYSTEM AND METHOD FOR ELICITING INFORMATION

(71) Applicant: Kurt L. Kimmerling, New York, NY (US)

(72) Inventor: Kurt L. Kimmerling, New York, NY (US)

(21) Appl. No.: 15/886,966

(22) Filed: Feb. 2, 2018

Related U.S. Application Data
(63) Continuation of application No. 14/622,896, filed on Feb. 15, 2015, now abandoned.
Application No. 14/622,896 is a continuation of application No. 13/795,168, filed on Mar. 12, 2013, now abandoned.
(60) Provisional application No. 61/654,119, filed on Jun. 1, 2012.
(60) Provisional application No. 61/683,752, filed on Aug. 16, 2012.

(51) Int. Cl. G06Q 30/02; G06Q 30/06; G06F 17/30

(52) U.S. Cl. CPC G06Q 30/0203; G06Q 30/0269; G06F 17/30386; G06Q 30/0631

(57) ABSTRACT

The disclosure relates generally to a system and a method for eliciting information from a user by reducing the dimensionality of an item preference data and computing user preferences based on question responses received from the user. The questions include information about pseudo-independent items based on the reduced dimensionality item preference data. The recommendation system and method are operable to make item recommendations to a group of users and for initiating a transaction involving at least one of the recommended items.

### CROSS-REFERENCE TO RELATED APPLICATIONS

This application is a continuation U.S. application Ser. No. 14/622,896, filed Feb. 15, 2015, entitled “System and Method for Eliciting Information”, which is a continuation of U.S. patent application Ser. No. 13/795,168, filed on Mar. 12, 2013, entitled “System and Method for Eliciting Information”, which claims the benefit of priority from U.S. Patent Application Ser. Nos. 61/654,119, filed on Jun. 1, 2012, and 61/683,752, filed on Aug. 16, 2012, both provisional applications entitled “System and Method for Making Recommendations.” The disclosures of the foregoing applications are expressly incorporated by reference herein in their entirety.

### FIELD OF THE DISCLOSURE

The disclosure relates generally to a system and a method for eliciting information. More particularly, the disclosure relates to a system and a method for eliciting information applying dimensionality reduction analysis techniques.

### BACKGROUND OF THE DISCLOSURE

Understanding user preferences is desirable to target advertising information and to improve user experiences while users engage web pages and mobile device applications. The value of predicted user preferences increases with their ability to predict user actions, such as purchasing decisions. User preferences can be inferred from implicit information by searching through user information such as purchasing history, credit card usage, demographic information, and other types of public and proprietary information. Such inferences are based on a large volume of information seemingly unrelated to the action to be predicted.

User preferences can also be obtained directly from users. For example, users can be asked to rank items. Ranked ordered data is useful. However, ranking items can require a significant amount of time and many users are unwilling or unable to spend the necessary time

A need exists to obtain information from users quickly and efficiently, and to determine the preferences of a user from a small amount of information.

### SUMMARY OF THE DISCLOSURE

A method and a system for eliciting information from a user are provided. In one embodiment, the method includes, by a processing device, processing instructions embedded in one or more non-transitory computer readable medium. The processing instructions are configured for reducing the dimensionality of item preference data corresponding to items and identifying pseudo-independent items, from the items, based on the reduced dimensionality item preference data. The method further includes outputting information for presenting questions based on the pseudo-independent items, the questions configured to elicit explicit pseudo independent items relative information from the user and receiving responses.

In one example, each of the questions includes at least two pseudo-independent items and each of the responses includes an item selection. In another example, each of the questions includes two pseudo-independent items question pairs, and each of the responses includes an item selection.

In another example, the outputting and the receiving are performed by processing application programming interface instructions.

In a further example, the method includes, by a user device application, presenting the questions and outputting the responses.

In one variation, the method includes generating second item preference data for additional items and performing a regression computation based on the second item preference data to fold-in the additional items into the item preference data.

In another variation, the method includes composing a user preference vector based on the responses and outputting an item recommendation based on the user preference vector.

In another variation, the method includes outputting the information to elicit the explicit pseudo independent items relative information from users in a group, and outputting an item recommendation based on the responses from the users in the group.

In another variation, the method includes receiving item reviews from reviewers, identifying from the reviewers those reviewers whose preferences are similar to the user's preferences, and outputting an item recommendation including a recommended item and the item reviews received from the identified reviewers and relating to the recommended item.

In another variation, the item preference data comprises preference data from respondents and a content driver, and dimensionality reduction has a content discriminating effect on the pseudo-independent items due to the content driver. In one example thereof, wherein items are movies and the content driver reflects whether the user has watched the movies, the discriminating effect discriminates likely watched movies from likely not watched movies, such that the questions will relate to more likely watched movies than if the content driver were not included in the item preference data.

In another variation, reducing the dimensionality of the item preference data generates item preference vectors corresponding to the items, and the method further comprises generating increased dimensionality item preference vectors by appending a content driver to the item preference vectors. In one example thereof, the items are movies, and the content driver includes a genre selected from the group comprising one or more of action, drama, comedy, horror/thriller, romance, and animated, wherein the content driver discriminates the items based on the genre.

In another variation, the method includes calculating item scores for the items, outputting an item recommendation including a recommended item and a preference value indicative of a predicted preference strength of the user for the recommended item, the item recommendation and the preference value based on the item scores, receiving an idiosyncratic feedback from the user indicative of the user's actual preference strength, and adjusting a future item score of the recommended item by an idiosyncratic amount related to the idiosyncratic feedback.

In another variation, the questions configured to elicit explicit pseudo independent items relative information from the user are operable to determine a user preference vector, and the method further includes outputting idiosyncratic questions configured to elicit idiosyncratic preferences.

In another variation, the questions further include saving the responses in a preference profile and outputting advertisements for the user based on the preference profile.

A method for serving advertisements to a user is also presented. In one embodiment, the method includes, by a processing device processing instructions embedded in one or more non-transitory computer readable medium, identifying the user when the user accesses a website and accessing a user preference profile of the user, the preference profile based on pseudo independent items relative information elicited from the user. The method also includes identifying preferred items based on item preference vectors and the user preference profile, the item preference vectors resulting from dimensionality reduction of item preference data corresponding to the items and serving advertisements relating to the preferred items.

Also presented herein are embodiments of a non-transitory computer readable medium and a system including the non-transitory computer readable medium, the non-transitory computer readable medium having processing instructions embedded therein for implementing the foregoing methods when processed by a processing device. In addition to the non-transitory computer readable medium and the processing instructions, the system includes the processing device.

In one embodiment, the processing instructions are configured to elicit information from the user. The processing instructions include: first processing instructions configured for reducing the dimensionality of item preference data corresponding to items and identifying pseudo-independent items, from the items, based on the reduced dimensionality item preference data; and second processing instructions configured for outputting information for presenting questions and receiving responses, the questions based on the pseudo-independent items to elicit explicit pseudo independent items relative information from the user.

In another embodiment, the processing instructions are configured to serve advertisements to a user. The processing instructions include: first processing instructions configured for identifying the user when the user accesses a website; accessing a user preference profile of the user, the preference profile based on pseudo independent items relative information elicited from the user; identifying preferred items based on item preference vectors and the user preference profile, the item preference vectors resulting from dimensionality reduction of item preference data corresponding to the items; and second processing instructions configured for serving advertisements relating to the preferred items.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIG. 1 is a block diagram of an information elicitation and transaction facilitation system according with an example set forth in the disclosure;

FIG. 2 is a graph illustrative of an information elicitation method according with an example set forth in the disclosure;

FIGS. 3 and 3A are block diagrams of information elicitation systems according with examples set forth in the disclosure;

FIG. 4 is a flowchart depicting a recommendation method according with yet another example set forth in the disclosure;

FIG. 5 is a flowchart depicting another recommendation method according with an example set forth in the disclosure.

FIG. 6 is a block diagram of a recommendation and transaction facilitation system according with another example set forth in the disclosure;

FIG. 7 is a flowchart depicting another recommendation and transaction facilitation method according with an example set forth in the disclosure;

FIG. 8 is a block diagram of a transaction facilitation system according with an example set forth in the disclosure;

FIGS. 9 to 11 are visual representations of recommendation information presented with a graphical user interface according with a further example set forth in the disclosure; and

FIGS. 12 and 13 is a visual representations presented with a graphical user interface for pre-survey filtering according with a further example set forth in the disclosure.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE DISCLOSURE

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

Generally, a system and a method for eliciting information elicit better data by asking better questions. The questions are derived from item preference data. The item preference data is processed to identify pseudo-independent items. Questions are then generated based on the pseudo-independent items. The questions solicit explicit pseudo-independent items relative information. For example, a question may ask a user to choose one of a few pseudo-independent items. The user's response may comprise information about the pseudo-independent item chosen by the user. The user's responses are processed to determine the user's preferences. The user's preferences can then be used to present item recommendations to the user, in marketing or political campaigns, and in any other manner. Better data results in better recommendations.

Questions that involve choosing between pseudo-independent items are very efficient, so only a few questions are needed to determine a user's preferences. Therefore, users are less likely to lose interest in answering the questions and participating in the process. The information eliciting system and method may be used to recommend multiple items to the user. The user may then choose to enter into a transaction with a provider of a recommended item. For example, the user may choose to order a movie from an online vendor.

The system may include an application programming interface (API) hosted by a web server. The API accesses an application program and a database including the item preference data. The application program and the API may execute processing instructions to generate the questions and select the item based on the responses. Online vendors may utilize their own web servers and databases to access the API and use the information elicitation method and system to promote transactions involving items they trade in commerce. For example, online vendors may use the information elicitation system to recommend digital items to a user. The user may then rent or purchase a recommended item and may download it from the vendor. The owner of the information elicitation system may grant access to the API to the online vendors in exchange for fees or other benefits.

In aggregate, the questions to solicit explicit pseudo-independent items relative information may be referred to as a user survey or a user item survey. The user item survey is designed to retain the user's attention. To that end, the choices are explicit, relative, current, intuitive and easy to undertake by a user. The user item survey is explicit because users chose from items related to the objective of the survey. In a movie recommendation system, for example, the survey may require the user to choose movies. They are relative because the responses are ranked relative to each other rather than in relation to an arbitrary rating, e.g. a value from an arbitrary scale. Also, items that have already been ranked may be constantly reassessed to keep current the survey information. Due to these characteristics, the user item survey is well suited for effectively eliciting user information.

Another characteristic of the user survey, whether a user item survey or another type of survey is used, is anonymity. Although the information elicitation system may be designed to require a user to create a virtual identity, the system does not have to require such identification. A user can anonymously use the information elicitation system since it is quick and also is not based on prior usage data. The discreet nature of the user survey makes it suitable for recommending adult items in the fields of entertainment, medicine and exercise, for example.

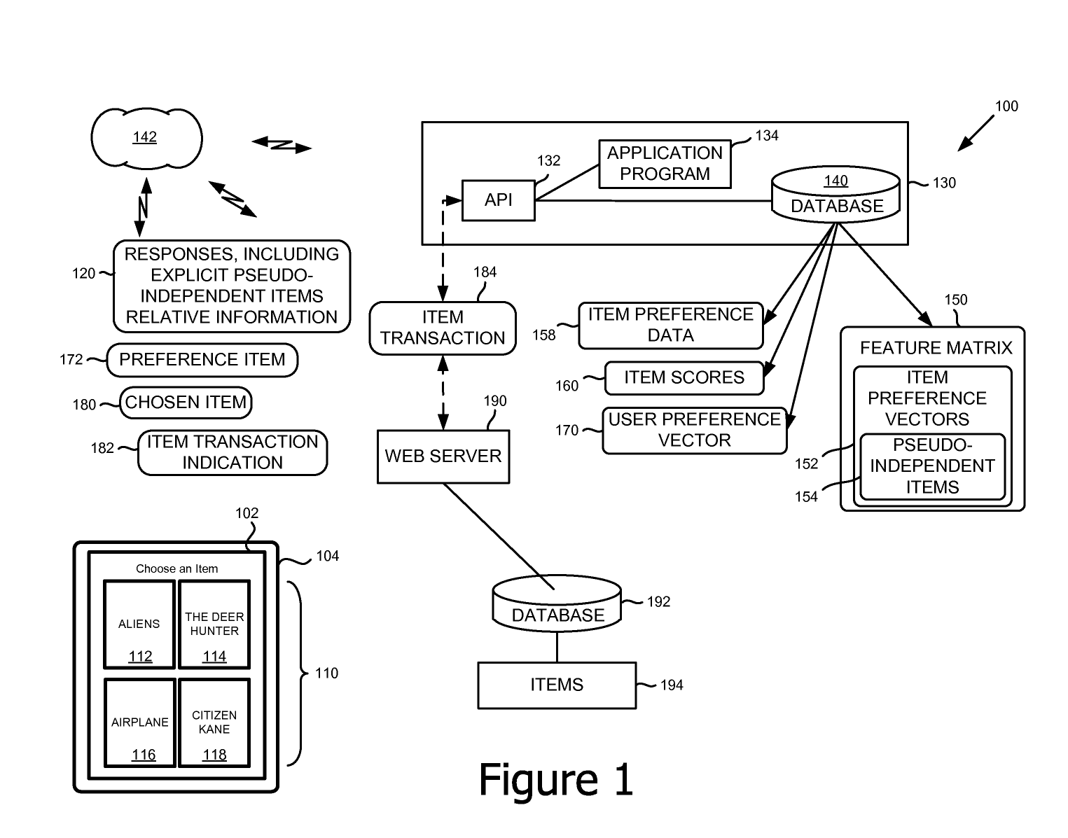

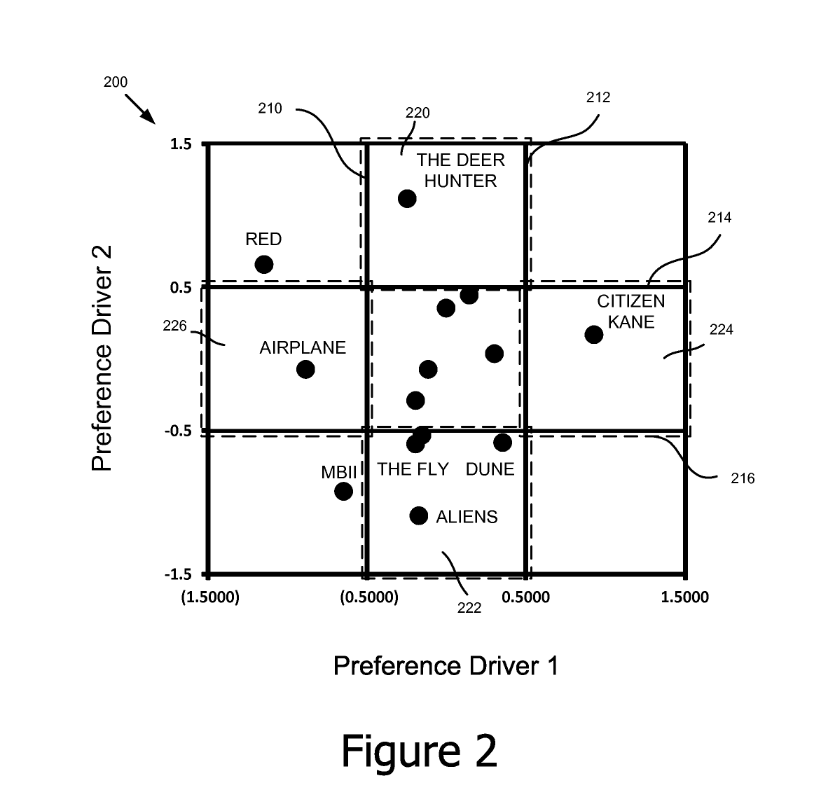

An embodiment of a system and method for eliciting information from a user to promote an online transaction will now be described with reference to FIGS. 1 and 2. FIG. 1 is a block diagram of an embodiment of an information elicitation system 100 including a user application 102 residing in a user device 104, and a system 130. The present embodiment may be described below with reference to movie items, although the embodiment is not limited to movies. Other items include songs, photos, software, any other digital content, and items that require physical delivery. System 130 may comprise one or more servers, such as a web server and a database server. System 130 is configured to transmit questions 110 to user application 102. A question 110 to solicit explicit pseudo-independent items relative information may include representations 112, 114, 116 and 118 corresponding to four items. Representations 112, 114, 116 and 118 may include text or images. The titles of four movies are shown (Aliens, The Deer Hunter, Airplane and Citizen Kane). User application 102 receives responses to the questions from the user and transmits responses 120 to system 130 via an information network 142. A response 120 may comprise, for example, an indication that the user chose the movie Aliens, the choice being explicit pseudo-independent items relative information. Based on responses 120, system 130 generates scores for the items. The scores represent the user's preferences. In one example, the highest score corresponds to the item most likely preferred by the user based on his/her responses.

System 130 may include an API 132, an application program 134, and a database 140. Database 140 may include item preference data 158 and item scores 160 computed based on a user preference vector 170, which is computed by processing responses 120. Database 140 may also include a feature matrix 150 including item preference vectors 152 obtained from item preference data 158. Pseudo-independent items 154 are determined from item preference vectors 152 to generate questions 110.

In one variation, system 130 transmits a recommendation to user application 102 including one or more preference item 172. The user can choose one of the one or more preference item 172 and initiate an item transaction 184 with user application 102. Upon the initiation, a chosen item 180 and an item transaction indication 182 are transmitted to a web server 190 of an online vendor to execute item transaction 184. Web server 190 may include a database 192 including a multitude of items 194. Preference item 172 may be selected from items 194 to ensure the online vendor can supply chosen item 180. As used herein, items 194 include digital items and item identifiers corresponding to physical and/or digital items.

In one variation, the questions are determined from pseudo-independent item pools based on thresholds. FIG. 2. shows a graph 200 illustrating preference driver values corresponding to items (e.g. movies). The preference driver values are computed from item preference data 158. Each item has a preference driver 1 value and a preference driver 2 value. A circular symbol is shown in graph 200 at the intersection of the preference driver values for each movie. Graph 200 includes thresholds 210, 212 corresponding to preference driver 1 and thresholds 214, 216 corresponding to preference driver 2. Graph 200 also includes pseudo-independent item pool areas 220, 222, corresponding to positive and negative pool areas for preference driver 2, respectively, and pseudo-independent item pool areas 224, 226, corresponding to positive and negative pool areas for preference driver 1, respectively. Pool areas 220, 222, 224, 226 are defined by thresholds 210, 212, 214, 216. The pool areas do not include the center and corner areas of graph 200. Movies graphed in the pseudo-independent item pool areas exhibit relatively large positive or negative values for one preference driver, indicating high preference, and relatively small positive or negative values for the other preference driver, indicating mild or neutral preference. Fourteen symbols are shown corresponding to fourteen movies. The values for each movie are shown in Table 1 below.

TABLE 1

| Movies | Driver 1 | Driver 2 |
|---|---|---|
| Red | (1.1500) | 0.6610 |
| Airplane | (0.8883) | (0.0700) |
| MBII | (0.6500) | (0.9200) |
| The Deer Hunter | (0.2500) | 1.1200 |
| The Fly | (0.1973) | (0.5897) |
| A Beautiful Mind | (0.1973) | (0.2870) |
| Aliens | (0.1768) | (1.0900) |
| Juno | (0.1579) | (0.5289) |
| Aladdin | (0.1185) | (0.0700) |
| Shark | (0.0055) | 0.3570 |
| Braveheart | 0.1401 | 0.4475 |
| Mars Attacks! | 0.2980 | 0.0393 |
| Dune | 0.3500 | (0.5800) |
| Citizen Kane | 0.9243 | 0.1715 |

As shown in Table 1, the values for the movie The Deer Hunter (graphed in pseudo-independent item pool area 220) are (0.2500) and 1.1200, which indicate a strong positive preference for preference driver 2 and a mild or almost neutral preference for preference driver 1. The values for the movie Aliens (graphed in pseudo-independent item pool area 222) are (0.1768) and (1.0900), which indicate a strong negative preference for preference driver 2 and a mild or almost neutral preference for preference driver 1. The movies graphed in a pseudo-independent item pool area comprise a pseudo-independent item pool, positive or negative. In the present example, the pseudo-independent item pools for preference driver 1 include the movies Citizen Kane (positive pool) and Airplane (negative pool). The pseudo-independent item pools for preference driver 2 include the movies The Deer Hunter (positive pool) and The Fly, Dune, Juno and Aliens (negative pool). Questions are drawn from the positive and negative pools.

In one variation, the information elicitation system and method are configured to eliciting group information. Making decisions in groups can often be frustrating and time consuming. For choosing an item to consume as a group (such as what movie to watch) the decision can be made easier with the help of the information elicitation system. The system administers a separate user survey to one, more than one, or all of the members of the group to generate user preference vectors for the members. The information elicitation system then generates item scores based on the user preference vectors of the group's members. The system may recommend items to the group based on the item scores.

The item preference data is initially obtained from respondents and is statistically analyzed to generate a reduced dimensionality item preference data, which includes the preference drivers and the preference driver values discussed with reference to FIG. 2. The reduced dimensionality item preference data may be structured as a matrix, which may be referred to as a feature matrix of item preference vectors. The item preference data includes a listing of items previously experienced or judged by respondents and item drivers obtained based on the respondent's experience or judgment. As used herein, a respondent is an individual providing input for the determination of item drivers, and a user is an individual that provides survey information. In a recommendation system, the user is also the recipient of the recommendation. In the case of a group of users, one, more than one, or all of the users are also recipients of the recommendation.

In another variation, the item preference data is updated by folding-in additional items so that the system and method for eliciting information stays current. The item preference data is updated over time by folding-in additional items. In one example, a group of respondents is surveyed and a multivariate regression is performed with the responses to determine the item preference vectors for the additional items. The additional item preference vectors are then combined with the existing item preference vectors in the feature matrix. In the case of movies, additional items may include movies not included in the item preference data, such as movies released after the last update of the item preference data.

In a further variation, the system and method for eliciting information are configured to be easy to use. In one example, a user can switch-out items from the questions, essentially redesigning the questions so that the responses are more relevant. The system may perform a likelihood computation with the switch-out information to refine the selection of future questions by excluding from the questions items that are similar to the switched out items. For example, a user may switch-out a movie from a question if he/she has not watched the movie. The likelihood computation enables the system to ask future questions based on movies that are different and dissimilar from the switched out movies. In one example, all movies that have been watched by the user are rated a positive 1 and the movies that have not been watched are rated a negative 1. The movies are then sorted into groupings based on whether the movies are likely to have been watched or not been watched by the user. The preference drivers thus comprise a user's “likely watched” vector. The likely watched vector is then used to select survey candidates, thereby avoiding likely not watched movies and improving the user's experience.

The foregoing embodiments of the system and method for eliciting information may be used to make recommendations. Individual preferences vary between individuals and between items being considered by the individuals. Preferences can be correlated and can be determined based on individual preference drivers. The ability to define items to make a recommendation based on a handful of independent drivers is very powerful. Input from respondents can be analyzed to identify the most important uncorrelated preference drivers for a group of individuals. Principal component analysis, matrix factorization, and singular value decomposition are exemplary known analytical techniques for identifying drivers. After input from respondents is analyzed using these techniques, the preferences of any individual can be summarized with a vector of real numbers. For example, a user's preference vector [1.3, −0.2, −1.8, 0.1], where each number represents a preference of the user for each driver, indicates the user likes driver 1, dislikes driver 3, and does not have a strong preference, positive or negative, for drivers 2 and 4. Likewise, an item can also be summarized with a vector of real numbers, wherein each number represents the degree to which the item exhibits the corresponding driver. The product of the individual's preference vector and the item's vector is indicative of how much the individual should like the item, with higher numbers indicating an item that should be more preferred. An item's vector can also be viewed as a point in space, wherein closely spaced points indicate similarly preferred items.

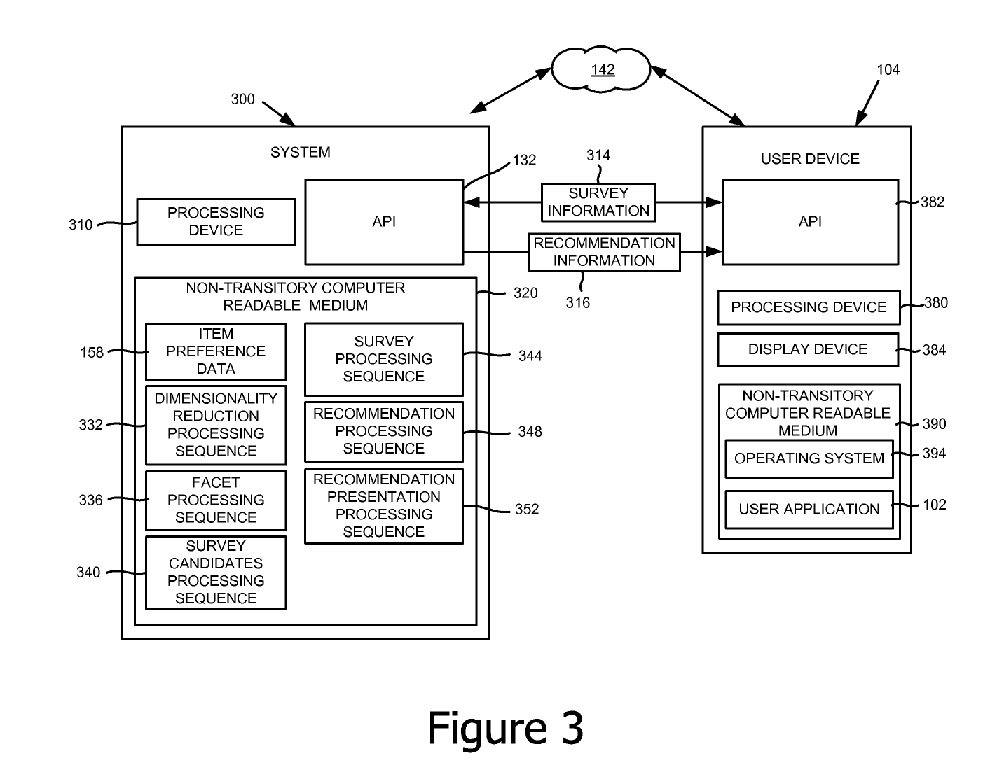

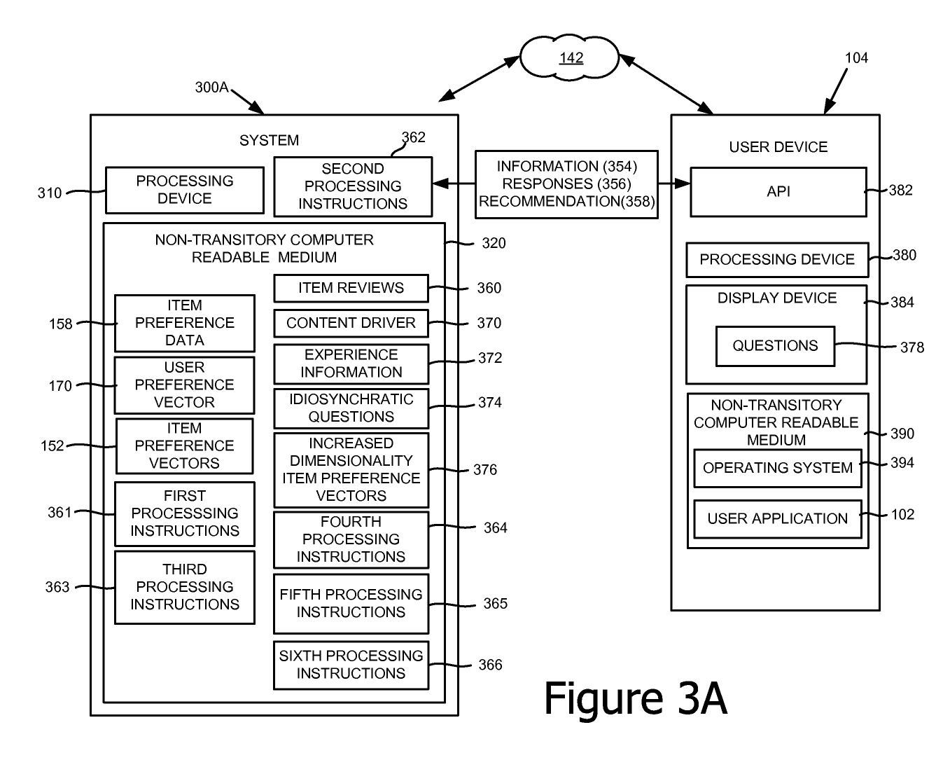

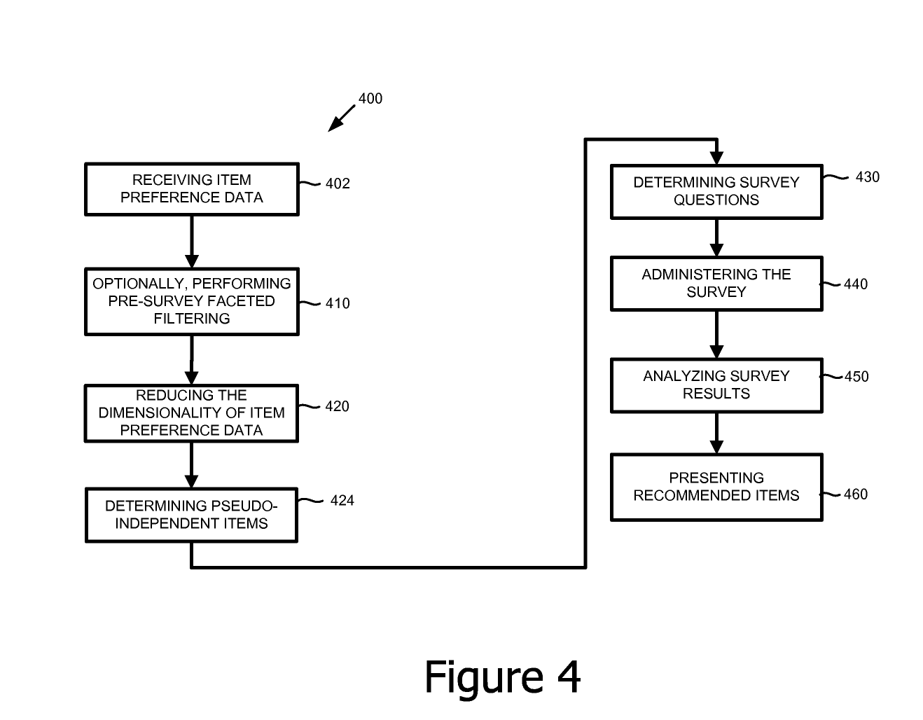

FIG. 3 is a block diagram of an embodiment of an information elicitation system according with the disclosure. In the present embodiment, the system is denoted by numeral 300. System 300 comprises a processing device 310, API 132 and a non-transitory computer readable medium, or memory, 320. Memory 320 has embedded therein item preference data 158 and a plurality of processing sequences, including a dimensionality reduction processing sequence 332, a facet processing sequence 336, a survey candidates processing sequence 340, a survey processing sequence 344, a recommendation processing sequence 348 and a recommendation presentation processing sequence 352. Dimensionality reduction processing sequence 332 may process the item preference data by computing principal components, transposing matrices, computing sum-products and generating a feature matrix, as explained with reference to FIG. 4. Facet processing sequence 336 receives facet data from users and applies the facet data to filter item preference data or recommendations. Survey candidates processing sequence 340 takes the output from dimensionality reduction processing sequence 332 or facet processing sequence 336 and identifies items for inclusion in survey questions. Survey processing sequence 344 takes the items and presents them as questions, receives survey information from users, uses the information to replace or select items in the questions and outputs a list of selected items. Exemplary survey information includes responses, veto commands and switch-out commands. Recommendation processing sequence 348 generates item scores based on the selected items and the feature matrix. Recommendation presentation processing sequence 352 presents the recommended items to the user based on the scores.

In one variation, system 300 includes a veto feature to make the system easier to use. In the present embodiment, recommendation presentation processing sequence 352 presents the recommended items to the user and also presents control buttons for vetoing a recommendation. The user vetoes one item after another until only one item remains. In another variation, the system is used by a group of users to arrive at a group recommendation. Recommendation presentation processing sequence 352 presents the recommended items to the users in order. After a user vetoes an item, a subsequent user is presented the recommendation list, less the vetoed item(s). The subsequent user vetoes another item by activating the control button. The veto process may continue until only one recommended item remains. In one example, after each of the users vetoed an item, recommendation presentation processing sequence 352 reverses the user order such that the last user to veto an item in one round of vetoing becomes the first user to veto an item in the subsequent round.

Also embedded in memory 320 are one or more operating systems and software applications operable to cause API 132 to establish communications with another system or device, for example user device 104. In one variation, system 300 comprises a server system. In another variation, system 300 comprises a user device. Exemplary user devices include personal computers, portable computers, an IPAD™, IPHONE™ or BLACKBERRY™ mobile device, a set-top box, a smart TV, a digital video disc player, a kiosk, and any device including a processing device, memory and an I/O interface operable to receive user commands and establish communications with other systems or devices. Generally, a set-top box, a smart TV, a digital video disc player, and a kiosk connect to the internet and to a television. A remote control associated with the set-top box, smart TV, digital video disc player, or kiosk is operable to access the internet and download media from remote services.

Also shown in FIG. 3 are user device 104 connected to recommendation system 300 through information network 142. Exemplary information networks include the Internet, WiFi wireless networks, cellular communication networks, and any communications system suitable to transfer information digitally between two systems or devices. User device 104 comprises a processing device 380, API 382, a display device 384 and a non-transitory computer readable medium, or memory, 390. Memory 390 has, embedded therein, an operating system 394 and user application 102. Operating system 394 is operable to cause processing device 380 to establish communications with system 300, and also to receive user commands or instructions or input via one or more user input devices including a keyboard, a mouse, a touch-screen and a voice-command driven input device.

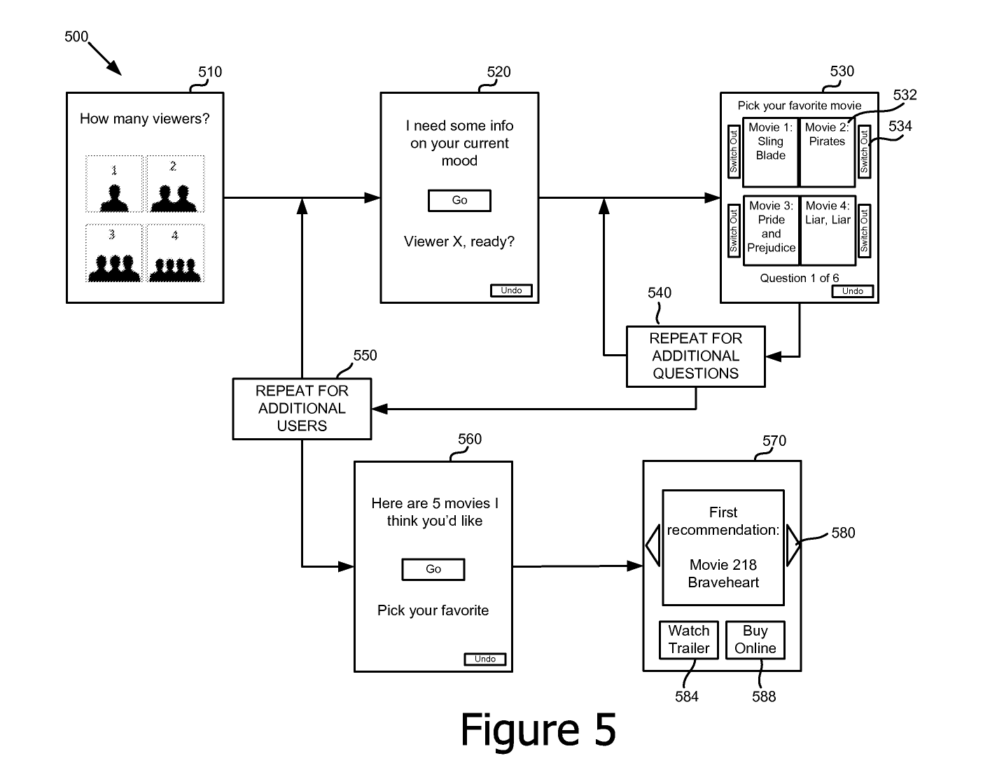

API 132 and API 382 are operable to share information between system 300 and user device 104. API 132 and API 382 transfer survey information 314 and recommendation information 316. Recommendation information 316 includes the user's inputs pertaining to the selection or rejection of an item. Selection or rejection is described with reference to FIG. 5.

FIG. 3A is a block diagram of another embodiment of an information elicitation system according with the disclosure. In the present embodiment, the system is denoted by numeral 300A. System 300A includes processing device 310, one or more non-transitory computer readable medium 320; and processing instructions embedded in the non-transitory computer readable medium, the processing instructions configured to elicit information from the user when processed by the processing device. The processing instructions include first processing instructions 361, second processing instructions 362, third processing instructions 363, fourth processing instructions 364, fifth processing instructions 365, and sixth processing instructions 366. First processing instructions 361 are configured for reducing the dimensionality of item preference data 158 corresponding to items 194 and identifying pseudo-independent items 154, from the items, based on the reduced dimensionality item preference data. The reduced dimensionality item preference data comprises item preference vectors 152. Second processing instructions 362 are configured for outputting information 354 for presenting questions 378 and receiving responses 356, the questions based on the pseudo-independent items to elicit explicit pseudo independent items relative information from the user. Survey information 314 may include information 354, responses 356, experience information 372, idiosyncratic questions 374 and questions 378. Survey information 314 may be used to generate content drivers 370 which can be used to filter items and to bias the responses in favor of, for example, types of users.

In one example, the system includes API 132, which includes the second processing instructions.

In another example, the system includes a user device application 102 operable to present questions 378 and output responses 356.

In one variation, third processing instructions are configured for generating second item preference data for additional items and performing a regression computation based on the second item preference data to fold-in the additional items into the item preference data.

In another variation, fourth processing instructions 364 are configured to generate third item preference data from responses from respondents, the third item preference data being different than the item preference data, wherein the regression computation is based on the second item preference data and the third item preference data.

In yet another variation, fifth processing instructions 365 are configured for receiving item reviews 360 from reviewers and identifying from the reviewers those reviewers whose preferences are similar to the user's preferences, wherein the second processing instructions are further configured for outputting an item recommendation including a recommended item and the item reviews received from the identified reviewers and relating to the recommended item.

In a further variation, sixth processing sequence 366 is configured for appending content driver 370 to item preference vectors 152 to generate increased dimensionality item preference vectors 376.

Item preference data 158 comprises one or more data structures, each relating a list of items to corresponding respondent data. To obtain item preference data 158, a plurality of respondents provide preference information in connection with the items in a list to calibrate the system. An initial calibration may be enhanced with subsequent calibrations to incorporate information about new items in the item preference data 158. An initial calibration will be described with reference to movies. The same process is applicable to other items. In the initial calibration, a number of respondents rank-order a set of commonly watched movies. Ideally, all the respondents have watched all the movies. If all the respondents rate all the items, the dataset may be referred to as a “dense dataset”. For example, a set of 100 commonly watched movies would be compiled and presented to a set of 50 respondents. Each respondent rank-orders the movies from 1 to 100. In one example, images of two movies are presented to the respondent, and the respondent chooses the movie he prefers. The process is repeated until, by comparing movies to other movies, the 100 movies are rank ordered. As described below, the rank-ordered responses are transformed so that they exhibit a uniform or normal distribution. Other distributions are also suitable.

The item preference data data structure comprises an array of items and respondent data. In one example, items are listed in rows and respondent data is listed in columns. The intersection of each row and column includes the data for the corresponding respondent (column) and item (row). In one variation, each respondent ranks all the items in the list, and the ranked data is transformed so that it is uniformly distributed with a mean equal zero and a range between −0.5 and 0.5. An exemplary portion of item preference data comprising four movies and six respondents is shown in Table 2.

TABLE 2

| Items/Respondents | R1 | R2 | R3 | R4 | R5 | R6 | . . . |
|---|---|---|---|---|---|---|---|
| Mars Attacks! | (0.3422) | 0.1078 | (0.5838) | 0.2119 | (0.4375) | (0.0936) | . . . |
| Juno | (0.4572) | 0.2824 | 0.1320 | 0.0108 | 0.3371 | 0.2869 | . . . |
| Braveheart | 0.2095 | 0.3106 | 0.3981 | 0.2805 | 0.0738 | 0.4090 | . . . |
| A Beautiful Mind | (0.4020) | 0.3313 | 0.3526 | 0.2122 | (0.2128) | 0.3256 | . . . |
| . . . | . . . | . . . | . . . | . . . | . . . | . . . | . . . |

Item preference data may further include facet information. The facet information is used to filter items. Therefore, the facet information relates to desired filtering. Exemplary movie facets include movie length, release date, rating, availability by service, genre, and any other characteristic suitable to categorize movies. Movie ratings include ratings from Common Sense Media, Inc., critics.com, Motion Picture Association of America, Inc., Film Advisory Board, Inc., and any other organization or individual based on the content of the rated movie. Movie ratings also include other rating mechanisms such as most viewed, release week gross sales and the like. Furthermore, item preference data may include an indicator indicating whether a respondent or user has watched the movie. Exemplary service provider facets include distance from current location, venue type, cost, rating and the like. For example, a user may be willing to drive 30 miles to eat at a highly rated but not expensive Chinese restaurant. With the appropriate system, including facet information, the user can choose the appropriate facets to receive recommendations meeting the criteria.

Assumptions may be used to substitute missing information. For example, if a respondent or user does not provide a response relative to an item, it may be assumed that the respondent is indifferent to the item. However, the density of the dataset (and the accuracy of the results based on it) decreases as the number of substitutions increases. An alternative approach is to fold-in new items, respondents and users into the existing dataset. Generally, folding-in is a process by which new items and users are calibrated to the existing dataset based on a reduced number of survey questions used to identify a corresponding vector. An embodiment of a fold-in method is described below.

Embodiments of the method disclosed herein can be implemented using a variety of dimensionality reduction techniques. Dimensionality reduction techniques are used to reduce the dimensionality, or complexity, of data without losing significant information. The techniques, in general, identify patterns in the data and characterize the information in the data based on the patterns. Less important patterns are removed or ignored, thereby reducing dimensionality without discarding significant information. One known technique is principal component analysis (“PCA”). PCA is mathematically defined as an orthogonal linear transformation of data to a new coordinate system such that the greatest variance by any projection of the data lies on the first coordinate (called the first principal component), the second greatest variance on the second coordinate (called the second principal component), and so on.

The data, referred herein as item based data or item preference data, comprises information obtained from respondents concerning items. As described above, the item preference data is obtained in a system calibration and, optionally, in subsequent calibrations. The item preference data is organized in a m×n matrix comprising M items data generated from information provided by each of N respondents. An exemplary portion of an item preference data matrix was presented above in Table 2. The mean user score is subtracted for each score. A matrix X results which has a zero empirical mean and is mathematically expressed as:

X={X[m,n]};m=1 . . . M;n=1 . . . N

The goal is to transform a given data set X of dimension M to an alternative data set of smaller dimension.

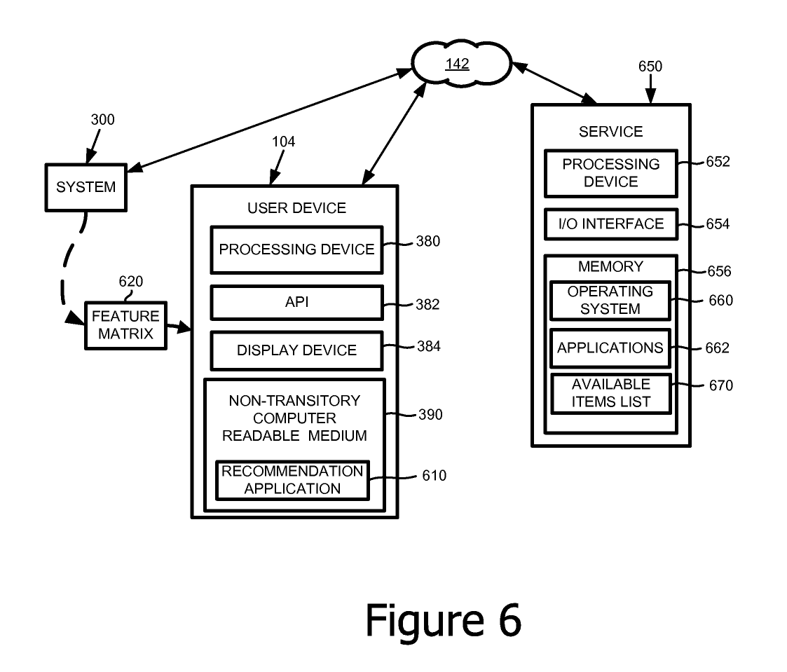

FIG. 4 is a flowchart 400 of an embodiment of a method according with the disclosure for recommending items. At 402, the method begins with receiving item preference data. Item preference data comprises an array of items and corresponding respondent information and can be received in any form, including user input and a data structure such as a file. In one variation described with reference to FIG. 6, the system receives item preference data and then transfers the item preference data or a feature matrix to a user device, in the same or a different data format. Item preference data includes a sufficient number of items to permit computation of preference drivers, e.g. principal components. An exemplary portion of item preference data was presented in Table 2.

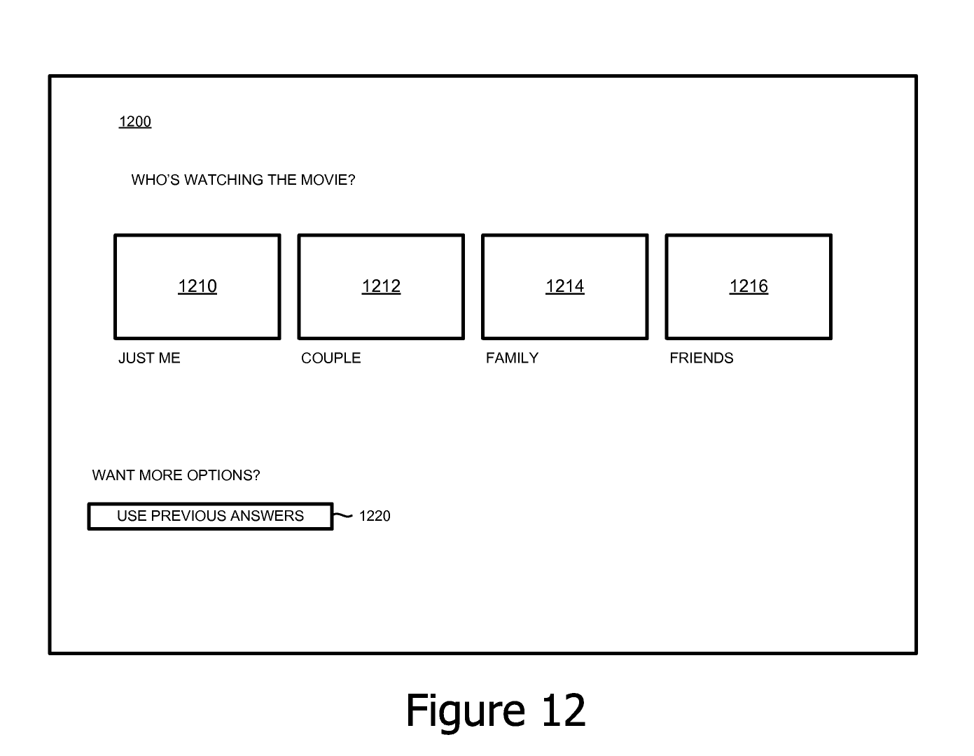

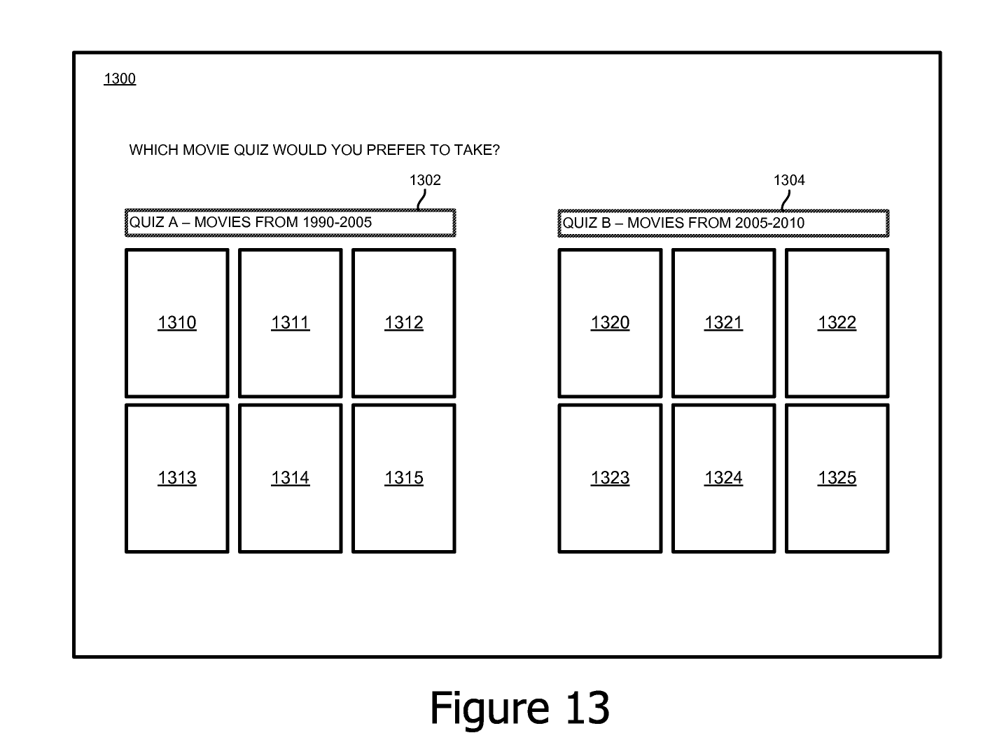

Optionally, processing continues at 410 with performing pre-survey facet filtering. Facet filtering comprises selection of a facet and filtering items according to the facet. Exemplary filtering includes inclusive and exclusive filtering. After filtering, a reduced number of items are available for further processing. In one example, facet filtering is applied to the item preference data, therefore a reduced number of items is available in the item preference data for computation of principal components. In another example, facet filtering is applied subsequent to the computation of principal components. In a further example, facet filtering is applied to a feature matrix before selection of potential question candidates. Computation of the feature matrix is described below. Exemplary GUI windows configured to select facets are described with reference to FIGS. 12 and 13.

At 420, the process continues with reducing the dimensionality of item preference data. Reducing item preference data dimensions involves different steps depending on the form of the item preference data. In one example, respondent information is normally distributed and centered, and processing continues to the computation of principal components. In another example, item preference data comprises rank data which is first normalized by a Cox-Box transformation to transform the ranked data to normally distributed data with a mean of 0.0. In one example, the normal data is scaled to have a standard deviation equal to about 1.0. to simplify matrix computations. Of course, the Cox-Box transformation can also be used to scale the item preference data. In a further example, respondent information is uniformly distributed with a range equal to about 1.0 and centered, and processing continues to the computation of principal components. As described above, a number of techniques are known for determining principal components to enable dimensionality reduction.

In one example, principal component analysis is performed to identify the principal components. First, a matrix Y of dimension N is computed as the Karhunen-Loève transform (KLT) of matrix X. A number of PCA computational methods are known, including the covariance, matrix factorization and singular value decomposition methods. A notable characteristic of dimensionality reduction techniques is that the principal components are determined analytically based on the respondent's input as opposed to being predetermined. Matrix Y comprises N rows (respondents) and N columns (principal components, e.i. PC1 to PCN). The principal components (eigenvectors) are ordered from left to right in order of importance. The elements of the matrix are referred to as the principal component loadings and may be referred to herein as the item attributes. An exemplary portion of a matrix Y computed from item preference data presented in Table 2 is shown in Table 3. As described previously, the number of items and respondents may be large. The number of items may exceed one-hundred and the number of respondents may exceed fifteen. Only six respondents and principal components, and four movies (items), are shown in Tables 3-5 to simply the illustrations, while ellipsis are shown to indicate that additional matrix elements exist.

TABLE 3

| Respondents/PCs | PC1 | PC2 | PC3 | PC4 | PC5 | PC6 | . . . |
|---|---|---|---|---|---|---|---|
| R1 | 0.0431 | 0.0487 | (0.1789) | 0.0585 | (0.3461) | 0.0037 | . . . |
| R2 | 0.3047 | (0.2157) | (0.0391) | 0.2007 | 0.1479 | 0.3203 | . . . |
| R3 | 0.1195 | 0.1093 | (0.4166) | 0.1108 | (0.3275) | 0.1793 | . . . |
| R4 | 0.2931 | 0.0184 | (0.0552) | 0.2662 | 0.0515 | 0.0500 | . . . |
| R5 | 0.1345 | 0.1527 | (0.4742) | 0.1721 | (0.1118) | (0.2856) | . . . |
| R6 | 0.2976 | (0.1024) | (0.4463) | (0.7530) | 0.0552 | 0.1832 | . . . |
| . . . | . . . | . . . | . . . | . . . | . . . | . . . | . . . |

The next step is to transpose matrix Y and apply the principal component loadings to the items. This is accomplished by calculating the sum-products of transpose Y and matrix X to obtain a matrix Z, in which

$${z}_{11} = \sum ( {y}_{11}^{*} {x}_{11} + {y}_{12}^{*} {x}_{12} … + {y}_{1 N}^{*} {x}_{1 N} )$$

$${z}_{21} = \sum ( {y}_{11}^{*} {x}_{21} + {y}_{12}^{*} {x}_{22} … + {y}_{1 N}^{*} {x}_{2 N} )$$

$$…$$

$${z}_{12} = \sum ( {y}_{21}^{*} {x}_{11} + {y}_{22}^{*} {x}_{12} … + {y}_{2 N}^{*} {x}_{1 N} )$$

$${z}_{22} = \sum ( {y}_{21}^{*} {x}_{21} + {y}_{22}^{*} {x}_{22} … + {y}_{2 N}^{*} {x}_{2 N} )$$

$$…$$

$${z}_{mn} = \sum ( {y}_{N 1}^{*} {x}_{M 1} + {y}_{N 2}^{*} {x}_{M 2} … + {y}_{N N}^{*} {x}_{MN} )$$

Alternatively, matrix Z is obtained by multiplying matrices X and Y. Matrix functions, including multiplication and principal component analysis, are available in MatLab™ software available from MathWorks, Inc. Principal component analysis can also be computed with GNU Octave software, available for download from ftp://ftp.gnu.org/gnu/octave.

Therefore, each element of matrix Z represents the degree to which each principal component is present in each item, based on the information from all the respondents. The elements in a row represent an item vector and may be referred to herein as item attributes. An exemplary portion of a transpose Y and matrix Z computed from item preference data presented in Table 2 is shown in Tables 4 and 5.

TABLE 4
transpose Y:

| PCs/Respondents | R1 | R2 | R3 | R4 | R5 | R6 | . . . |
|---|---|---|---|---|---|---|---|
| PC1 | 0.0431 | 0.3047 | 0.1195 | 0.2931 | 0.1345 | 0.2976 | . . . |
| PC2 | 0.0487 | (0.2157) | 0.1093 | 0.0184 | 0.1527 | (0.1024) | . . . |
| PC3 | (0.1789) | (0.0391) | (0.4166) | (0.0552) | (0.4742) | (0.4463) | . . . |
| PC4 | 0.0585 | 0.2007 | 0.1108 | 0.2662 | 0.1721 | (0.7530) | . . . |
| PC5 | (0.3461) | 0.1479 | (0.3275) | 0.0515 | (0.1118) | 0.0552 | . . . |
| PC6 | 0.0037 | 0.3203 | 0.1793 | 0.0500 | (0.2856) | 0.1832 | . . . |
| . . . | . . . | . . . | . . . | . . . | . . . | . . . | . . . |

TABLE 5
matrix Z:

| Items/PCs | PC1 | PC2 | PC3 | PC4 | PC5 | PC6 | . . . |
|---|---|---|---|---|---|---|---|
| Mars Attacks! | 0.2918 | 0.0393 | 0.8880 | (0.2983) | 0.2077 | (0.4644) | . . . |
| Juno | (0.1579) | (0.5288) | (0.7011) | 0.0809 | 0.2703 | 0.1372 | . . . |
| Braveheart | 0.1401 | 0.4475 | (0.5603) | (0.2486) | 0.2158 | 0.3543 | . . . |
| A Beautiful Mind | (0.1973) | (0.5897) | (0.5329) | 0.0492 | 0.3164 | 0.3113 | . . . |
| . . . | . . . | . . . | . . . | . . . | . . . | . . . | . . . |

The next step is the selection of an arbitrary number of principal components to form a feature matrix. As described below, more or fewer principal components are selected to form the feature matrix. For simplicity, the feature matrix will be described as having four principal components, the four left-most principal components of matrix Z, also described as principal components A, B, C and D. An exemplary feature matrix is shown in Table 6, illustrating reduction of the dimensionality of matrix Z. Above each column, the standard deviation for the attributes in the column is shown, i.e. 0.3329, 0.1532, etc.

TABLE 6
feature matrix:

| | Standard Deviation | | | |
|---|---|---|---|---|
| | 0.3329 | 0.1532 | 0.1121 | 0.0987 |
| | PCs | | | |
| Items | PC1 | PC2 | PC3 | PC4 |
| Mars Attacks! | 0.2918 | 0.0393 | 0.8880 | (0.2983) |
| Juno | (0.1579) | (0.5288) | (0.7011) | 0.0809 |
| Braveheart | 0.1401 | 0.4475 | (0.5603) | (0.2486) |
| A Beautiful Mind | (0.1973) | (0.5897) | (0.5329) | 0.0492 |
| . . . | . . . | . . . | . . . | . . . |

The present method embodiment continues, at 424, with determining the pseudo-independent items for inclusion as survey candidates. Pseudo-independent items may be selected by evaluating the feature matrix values to identify the items with the largest positive and negative attributes for a single principal component and with small attributes for the remaining principal components are selected. As seen in Table 6, the attribute corresponding to PC3 and the movie Mars Attacks! equals 0.8880 while the remaining attributes for the movie are less than 0.3; therefore, the movie Mars Attacks! is a positive question candidate for a question requiring PC3 (or C). The pseudo-independent items may also be determined as described with reference to FIG. 2. The pseudo-independent items may be selected from pools of pseudo-independent items in random or predetermined order.

In one variation of the present embodiment, the items are selected after comparing their attributes to a variation factor comprising a constant times the standard deviation of the attributes for a principal component of the feature matrix. This calculation distinguishes items based on the relative size of their attributes with respect to the same principal component so that a single threshold, or constant value, can be used. In one example, the constant is 1.25, and the selection threshold can be expressed as:

K(PC)ⱼ=1.25*Std. Dev.[PC₁ⱼ:PC_{Mj}]

Regarding the movie Braveheart in Table 6, the second attribute, 0.4475, is not very different from the absolute value of the third attribute, 0.5603, yet, as shown below in Table 7, the second attribute does not result in a positive comparison in a case where the third attribute does. The distinction is based on the standard deviation of the columns and the constant, which can be adjusted to be more or less inclusive.

In another variation, a threshold is predetermined for each principal component. In one example, each predetermined threshold is smaller than the threshold for the preceding, more important, principal component. Thresholds were disclosed above with reference to FIG. 2.

Having defined the threshold criteria, the next step is to select items by comparing attributes and thresholds. In one example, in the case of four principal components there are four thresholds, and eight comparisons are made. The first four comparisons identify candidates for the positive preference and the other four identify candidates for the negative preference. In the latter comparisons, the threshold is first multiplied by (−1). If only one comparison is positive, meaning that the attribute exceeds the threshold, then the item is a question candidate. If none or more than one comparison is positive, the item is not a candidate. In another example, four comparisons are made to the absolute value of each attribute. If only one comparison is positive, then the item is a question candidate. If none or more than one comparison is positive, the item is not a candidate. The sign of the value determines if the item is a candidate for a positive or a negative preference choice. In both examples, if the positive comparison results from an attribute in the first column, the item is a candidate for a question including principal component A. If the positive comparison results from an attribute in the second column, the item is a candidate for a question including principal component B, etc. An example implementing the foregoing method using the standard deviation formula to calculate the threshold is shown below in Table 7, where the number 1 represents a positive comparison. A count column indicates the number of positive comparisons. Therefore, according to the method, the first and third items, having a count of 1, are pseudo-independent and, therefore, are question candidates. The second and fourth items are not question candidates.

TABLE 7

| Items/PCs | PC1+ | PC2+ | PC3+ | PC4+ | PC1− | PC2− | PC3− | PC4− | Count |
|---|---|---|---|---|---|---|---|---|---|
| Mars Attacks! | 0 | 0 | 1 | 0 | 0 | 0 | 0 | 0 | 1 |
| Juno | 0 | 0 | 0 | 0 | 0 | 1 | 1 | 0 | 2 |
| Braveheart | 0 | 0 | 0 | 0 | 0 | 0 | 1 | 0 | 1 |
| A Beautiful Mind | 0 | 0 | 0 | 0 | 0 | 1 | 1 | 0 | 2 |
| . . . | . . . | . . . | . . . | . . . | . . . | . . . | . . . | . . . | . . . |

Having determined the pseudo-independent items, the method continues, at 430, with determining survey questions. The survey questions may be posed as a choice between pseudo-independent items. Thus, for one principal component, two items are selected for the questions. For two principal components, four items are selected. Requiring a user to choose one of four items effectively addresses the relative importance of each principal component. In the present embodiment, four principal components are used to determine a user's current preferences by asking only six questions. The first question requires the user to choose an item from a set of items exhibiting preferences A+, A−, B+ and B−. Subsequent questions pair principal components A/C, A/D, B/C, B/D and C/D, each possible pair of principal components defining a question. The method essentially identifies an orthogonal set of items. The degree to which orthogonality is preserved depends on whether items correlated to a single principal component can be found. However, even without complete orthogonality the method described herein enables a recommendation of items to be made to a user matching the user's current mood, represented by the answers to the six questions. The degree of orthogonality can be defined in a computational step.

In a variation of the present embodiment, less than four principal components are used. For example, only one question is presented based on two principal components, and three questions are presented based on three principal components. In another variation of the present embodiment, more than four principal components are used. For example, ten questions are presented based on five principal components. More questions increase precision at the expense of usability. As described further below, an extension of the method enables recommendation of items to multiple users. The next step is to select items for survey questions from the pool of pseudo-independent items generated based on the foregoing criteria. The question candidates can be selected in various ways. A number of variations will be described in the context of movie recommendations, with the understanding that the methodology is applicable in other contexts as well, with the criteria suitably modified to the other contexts. All the pseudo-independent items for a particular category, e.g. PC1+, comprise a pool. In one variation, potential candidates are selected sequentially from the pool. According to Table 6, for example, Mars Attacks! would be the first question candidate for a PC3+ question and Braveheart would be the first question candidate for a PC3− question. In another variation, the pool of potential candidates is randomized and then item candidates are selected sequentially from the pool. Randomization ensures that the item candidates in a first usage instance and subsequent usage instances will be different. In a further variation, the pool of potential candidates is ordered according to the score of the uncorrelated principal component, such that items with higher attributes are presented before items with lower attributes.

In a further variation, the pool of candidates is filtered to include previously watched movies. As described with reference to FIG. 5, when questions are presented, the user can switch-out or reject items in the question so that the questions focus on previously experienced items. In the case of movies, after switching out unwatched movies, the user can answer a question by choosing a movie from among four previously watched movies. As the recommendation system is used by a user, and the user identifies previously watched movies, the system stores this information and, in subsequent instances, the system identifies question candidates from the sub-pool of previously watched movies to minimize the time wasted switching out movies and, thus, enhancing the user experience. In one variation, the user completes a “previously seen” survey in which the answers to the question “have you seen this movie” include seen (1), not seen (−1), and no information (0).

If the pool is not large enough, some unwatched movies will be presented in the questions. In a yet further variation, in addition to previously watched movies, the sub-pool includes movies likely to have been watched. In one example, the likely to have been watched movies are selected by comparing the vectors of the previously watched movies to the vectors of the items in the pool in a nearest-neighbors analysis.

The present method embodiment continues, at 440, with administering the survey. As explained before, four items are presented, which are selected based on paired principal components, positive and negative. The user is required to choose one of the four items. After choosing one item, the next question is presented, until all the questions have been presented. In one variation, the user is given the choice to exclude or switch-out an item from a question. For example, the user may not be familiar with an item in the question. If an item is rejected, the item is replaced with another candidate from the pool of potential question candidates. Selection and rejection are described in more detail with reference to FIG. 5.

The present embodiment of the method continues, at 450, with analyzing survey results to determine the user's preference vector. In the case where four principal components are used, there are six chosen items and eighteen rejected items, therefore, there are twenty four item vectors representing the current mood of the user. In one variation, the attributes of the six vectors corresponding to the six chosen items are averaged to generate the preference vector. In one example, the preference vector is weighed with the attributes of the rejected items. In another example, the average of the vectors corresponding to the not chosen items is subtracted from the average of the vectors corresponding to the chosen items.

The recommendation method and system described herein is not limited by the form of the survey. While a multiple-choice survey has been described hereinabove, other inquiry forms are suitable for obtaining question responses from users relative to pseudo-independent items. In one variation, the method comprises asking each user to rank-order a limited number of items. In another variation, the users answer whether they like or dislike items. The question responses are then analyzed to define user preference vectors utilizing any computational method, including those described above.

Having determined the user's preference vector based on the survey, the next step is to generate item scores. The items are then ranked according to the scores. The items with the highest scores are the recommended items. In one example, the sum-product of the preference vector and the feature matrix generates the item scores. In another example, the feature matrix is multiplied by the preference vector to generate the item scores. In one example, faceted filtering is applied to filter out items from a potential recommendation list.

In a further variation, in which the recommendation system is used to recommend items to a group of users, the user's preference vectors are computed based on the item vectors of the items chosen and not chosen by each of the users in the group. As in the case of the single user, the computation can be based on the chosen items alone or it can be based on the chosen and unchosen items. In one example, a vector is computed for each user by summing the attributes of the items chosen by the user, for each principal component. Then, the vectors are normalized to the same magnitude by dividing each vector by its length. This results in a user preference vector, normalized, for each user. The item scores are then computed for each user as in the case of a single user. In another example, the items are rank ordered for the user and given a percentile ranking. The scores per user are then used to determine the recommendations. In one example, the group item score is the smallest of the users' scores for the item, which may be referred to as the “least misery” score. In another example, the item score is the average of the users' scores for the item.

In a further example, the group recommendation is intentionally biased in favor of a user. For instance, a couple may chose “more for her” one week and “more for him” the next week. Biasing may be accomplished by weighing the group preference vector to reflect one person's misery being more important than another person misery. The item scores are calculated for each item based on the score from each individual (A and B). An even weight is determined by the formula W=100−min(100−scoreA, 100−scoreB) or, as described above, by the average of the scores. A way to bias in favor of A is determined by the formula Wa=100−min(100−scoreA, (100−scoreB)*Scalar), where Scalar is less than 1 (for instance 0.5). Alternatively, a weight to bias in favor of A is determined by the formula Wa′=(scoreA+ScoreB*Scalar)/(1+Scalar), where Scalar is less than 1 (for instance 0.5).

The present method embodiment continues, at 460, with presenting recommended items. In one variation, a list of recommended items is presented. In another variation, the top item is presented along with “next” and “last” icons for presenting previously presented (last) and the next recommended item (next).

In the movie context, users may answer questions involving movies they have not watched based on their perceptions of the movies. For example, they may switch out movies in certain genres. The users may be disappointed if the system recommends a movie of the genre they switched-out, even though the recommendation is statistically valid. Exclusionary content filters address the foregoing problem by forcibly excluding movies according to content categories, e.g. genre.

In another embodiment of a recommendation system, a dynamic recommendation engine switches between content filtering and collaborative filtering according with the strength of the users' responses. In the present embodiment, the item preference data comprises preference data from respondents and a content driver. The dimensionality reduction has a content discriminating effect on the pseudo-independent items due to the content driver. In one example, increased dimensionality item preference vectors are generated by the processing instructions by appending a content driver to the item preference vectors. Exemplary content drivers include types of items (e.g. movie genre), experience factors (e.g. watch or not watched, loved or hated), and any other type of content.

As in facet filtering, content drivers enable filtering. An item may be included or excluded based on the content attributes (i.e. the weight of a driver for a particular item) regardless of the preference attributes of the item preference vector. An R-rated attribute may cause exclusion of all R-rated movies, for example. Instead, the dynamic recommendation engine determines item scores based on the preference attributes as determined from the survey responses and the content attributes.

In one example, six content drivers are appended to the item preference vectors. The six drivers represent action, drama, comedy, horror/thriller, romance, animated genres. Of course, more or fewer drivers may be used. Each movie in a particular genre is assigned a weight of positive one for the corresponding driver and 0 otherwise. A movie may fit in more than one genre. The assigned weights are then scaled so that the standard deviation of each content driver is some relationship with the other preference drivers. In one variation, the six genre drivers are scaled so that their collective standard deviation is approximately equal to the standard deviation of the second preference driver. In another variation, the six genre drivers are scaled so that their collective standard deviation is approximately equal to the third or fourth preference driver. Matching the standard deviation of a content driver to a specific preference driver ensures that both drivers have the same influence on the item's score. The content weights are then normalized across all movies to have a mean of 0.

The users' preference vector is calculated in the same way as described above. Then, the weights of all drivers are normalized so that the total distance of a vector is equal to 1. If the user chooses an animated movie in every question, for example, despite some animated movies being good and some bad, a score calculated with only the preference drivers will have a weak value due to averaging positive and negative weights. On the other hand, the weight of the animated movie content driver will be high, so the score calculated by the dynamic recommendation engine will also be high. In this manner the dynamic recommendation engine uses collaborative filtering drivers, e.g. preference drivers, and content filtering drivers according to the strength of the signal of each to provide a better recommendation. If the responses to the questions do not express a strong collaborative filter signal, then the content drivers will dominate. If the responses express a strong signal, then the collaborative filter drivers will dominate. Use of content drivers by the dynamic recommendation system does not affect the formulation of questions. The survey questions are still based on the item preference drivers.

FIG. 5 is a flowchart 500 of an embodiment of a general recommendation method according with the disclosure for navigating the recommendation system and selecting items. A GUI embedded in memory comprises instructions for presenting visual representations of questions and control icons, and receiving user information. Visual representations comprise a user selection screen 510, a survey initiation screen 520, a survey question screen 530, a recommendation process screen 560 and an item recommendation screen 570. In one variation, the GUI is embedded in a system, e.g. system 130 or 300, and the visual representations are visible in a user device functioning as a web client. In another variation, the GUI is included in a recommendation application operable in a user device, such as the recommendation application 610 described below with reference to FIG. 6.

The method begins after the user activates the GUI, at which time user selection screen 510 is presented by the GUI. The GUI receives a user input indicating how many users will participate in the recommendation process. Then, the GUI presents survey initiation screen 520 to indicate to the user that information is required to assess the current mood of the user. The screen also displays a user number, shown as “X”, to indicate which of the number of users should next provide mood information. If one user has been selected, then X=1. If four users have been selected, then X will comprise 1, 2, 3 or 4 depending on how many surveys have already been completed. In one variation, each user accesses the user device, in turn, to complete the survey. In another variation, users log into the system and take the surveys with different personal devices.

Survey question screen 530 is presented next showing four item images 532, i.e. movies. Switch-out buttons 534 enable the user to switch-out the item located next to each button 534. One of the items must be selected to proceed. An item may be selected by touch in the case of touch-screens, with a mouse pointer or with any other user interface. After the item is selected, at 540, the process is repeated for as many survey questions as are coded in the system. After the last question is answered, at 550, the process is repeated for as many users as were selected with user selection screen 510. The value of X is incremented accordingly, until the last user survey has been completed.

The method continues with presentation by the GUI of recommendation process screen 560. After the user indicates desire to view the recommendations, i.e. activating a “go” control button, item recommendation screen 570 is presented showing the first recommendation. Navigation buttons 580 are presented to navigate to the previous or next item recommendation. In the present embodiment, a “watch trailer” button 584 is provided to enable the user to preview the recommended movie. A button 588 is provided to enable the user to order the movie from an online service provider. A system API communicates with an API of the service to authenticate the user's account and authorize the transaction. The user may authenticate the account at any time prior to ordering an item. In a variation of the present embodiment, the user logs into the system of the service provider and the recommendation system API automatically downloads movie availability information from the service provider. In one example, the recommendation system limits recommendations to available movies.

FIG. 6 is a block diagram of another embodiment of a recommendation system according with the disclosure. The system comprises system 300 and a recommendation application 610. Recommendation application 610 is stored in the memory of a user device and comprises a GUI operable to administer a survey and present recommendations. User device 104, including non-transitory computer readable medium, or memory 390, is shown. As described above, exemplary user devices include personal computers, portable computers, an IPAD™, IPHONE™ or BLACKBERRY™ mobile device, a set-top box, a smart TV, a digital video disc player, a kiosk, and any device including a processing device, memory and an I/O interface operable to receive user commands and establish communications with other systems or devices. A dashed line illustrates the transfer of a feature matrix 620 from system 300 to user device 104. The transfer occurs through information network 142 and is shown separately for clarity.

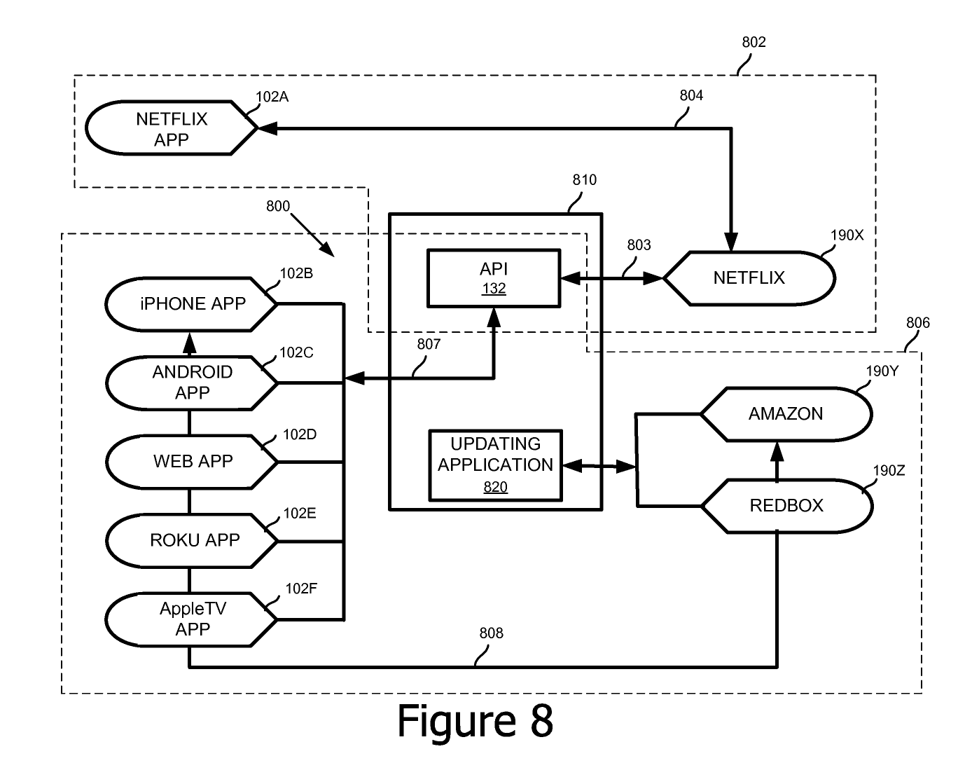

Also shown in FIG. 6 is a service 650, e.g. a movie delivery service, connected to the recommendation system through information network 142. Service 650 comprises a processing device 652, an I/O interface 654, and a memory 656. Memory 656 has embedded therein an operating system 660, applications 662, and an available items list 670. An exemplary application is an API for delivering available items list 670 to either system 300 or user device 104. In one variation, all communications concerning the recommendation system, except those in connection with login, authentication and payment, flow between user device 104 and system 300, and between system 300 and service 650. In other words, user device 104 communicates through system 300 to service 650. In another variation, user device 104 communicates directly with service 650, and service 650 updates system 300 with respect to movie transactions and compensation based on items ordered using the recommendation system. System 130 is equivalent to, and interchangeable with, system 300. Exemplary business processes in which a service, or online vendor, communicates with system 300 and a user device application such as recommendation application 610 is described with reference to FIG. 8.

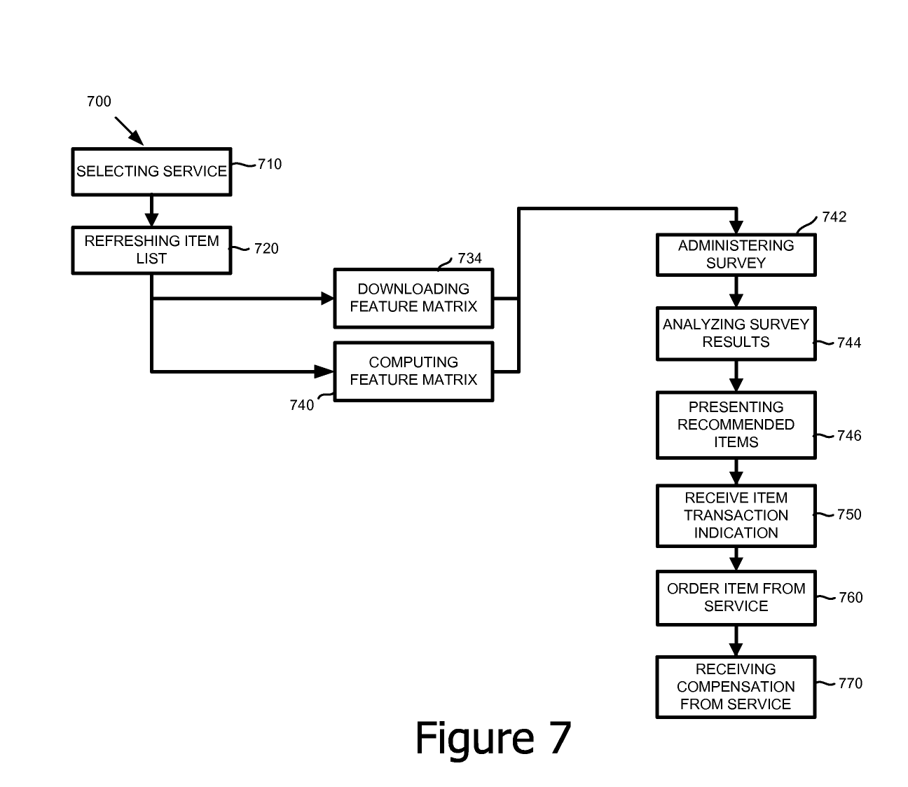

FIG. 7 is a flowchart 700 of another embodiment of a method according with the disclosure in which the recommendation system provides information to a user device, and the user device performs some of the item preference or feature matrix processing. The method may be implemented with the system described with reference to FIG. 6. The method begins, at 710, with selection of a service. In one example, the GUI presents the user with a number of service options (e.g. as shown on FIG. 8) and the user activates a control button to choose one of the services. At 720, the service refreshes the item list stored in the user device. The item list may include additional information operable for facet filtering. In one variation, system 300 computes and pushes the feature matrix and, at 734, the feature matrix is downloaded by the application. In one example, system 300 also pushes item images for the survey questions. In another example, system 300 receives the available items list and pushes a feature matrix based on the available items. Once the recommendation application in the user device has a feature matrix, the application may run without internet access. In another variation, the recommendation application in the user device is operable, at 740, to download item preference data from system 300 and compute the feature matrix.

After the recommendation application has the feature matrix, the GUI, at 742, administers the survey. At 744, the application administers and analyzes the survey results and, at 746, presents recommended items, in the manner previously described with reference to FIG. 5. In one example, the administration, analysis and presentation functions are performed by processing sequences such as survey processing sequence 344, recommendation processing sequence 348 and recommendation presentation processing sequence 352. In one example, presentation includes providing users control buttons with which to veto items, as described previously with reference to recommendation presentation processing sequence 352. In one variation of the present embodiment, the recommendation application downloads the survey questions from system 300 and uploads the survey results to system 300. System 300 analyzes the survey results and then provides the recommendations to the application.

At 750, the application receives an item transaction indication. An exemplary transaction indication is a user command to order a movie. The user may order the movie by activating the appropriate control button, such as control button 588 described previously with reference to FIG. 5. At 760, the recommendation application orders the selected item from the service. Then, at 770, the service provides compensation to system 300. In one example, the order includes a token referencing the recommendation system, which enables the service to compensate system 300 with payment equal to a portion of the transaction or a fixed amount.

FIG. 8 is a block diagram of an implementation of system 800 configured to enable a plurality of user device applications, exemplified as user applications 102A-F, to engage in transactions with various services, or online vendors, exemplified as web servers 190X-Z. System 800 includes a system 810 including API 132 and an updating application 820. System 810 may be configured as system 130 or 300 to implement any of the methods described above. FIG. 8 also illustrates two business processes enclosed in dashed lines and denoted by numerals 802 and 806. Both business processes rely on API 132 administer surveys and generate recommendations.

In business process 802, lines 803 and 804 represent communication lines (copper lines or wireless lines or both) between web server 190X and API 132, and between web server 190X and application 102A. Web server 190X and application 102A are online vendor components, illustratively a Netflix server and a Netflix application. The online vendor develops and implements its servers and applications as it desires, and accesses API 132 to administer surveys to users of its applications and to receive recommendations which the online vendor then provides to its applications. The applications include mobile applications and also web pages. System 810 includes the necessary databases and applications to receive survey requests and output survey questions via API 132, to process the survey information provided by the online vendor, and to output the recommendations, also via API 132. In essence, system 810 is a recommendation server, and the online vendor is a recommendation client.

In business process 806, line 807 represents communication lines (copper lines or wireless lines or both) between API 132 and applications 102B-F. Line 808 represents communication lines (copper lines or wireless lines or both) between web servers 190Y and 190Z and applications 102B-F, illustratively online vendors Amazon and Redbox. The online vendors communicate with updating application 820 to provide lists of current offerings, such as available movies. Updating application 820 updates the recommendation system databases with the up-to-date items. An application program (not shown), illustratively application program 134, accesses API 132 to administer surveys to users of applications 102B-F and to send recommendations to applications 102B-F, also via API 132. In the present example, applications 102B-F are the recommendation clients. Applications 102B-F may then access web servers 190Y and 190Z via line 808 to request a movie preview or enter into an online transaction with the online vendors.

The foregoing embodiments have been described with reference to a feature matrix including item drivers computed based on input from an initial set of respondents. Additional items and individuals may be added by reprocessing the entire item preference data. While reprocessing may yield a dense dataset, it is not always possible or desirable to reprocess. Alternatively, additional items and individuals may be added to the system in a process termed “fold-in”. As described above, the preference drivers are identified based on the item preference data which is, ideally, dense. Every item and respondent is summarized as a vector representing the drivers. By the fold-in process, a vector is determined for each new item and individual by extrapolating from the feature matrix. The quality of data for an item or individual decreases with the number of extrapolations. Therefore, it is preferable to extrapolate preference vectors for individuals directly from the dense dataset. A preference vector for a new individual can be found based on a small survey, as described above.

According to one embodiment of the recommendation method, a new item is folded in by performing a multivariate regression analysis. In one variation thereof, the method includes generating second item preference data for additional items and performing a regression computation based on the second item preference data to fold-in the additional items into the item preference data.

In one example, the initial respondents, or a subset of them, rank additional items by comparing them to the initial items. The preference vectors of the initial respondents are known. In this example, second preference data is generated based on the responses from the initial respondents. The new item's vector is determined by a multivariate regression in which each respondent's response is an observation, the dependent variable is the set of ranks from each user, and the independent variables are the preference vectors of each user. The regression coefficients (without intercept) produce the most likely vector describing the new item.

In another variation thereof, the method further includes generating third item preference data from responses from respondents, the third item preference data being different than the item preference data. The regression computation is based on the second item preference data and the third item preference. In one example, new respondents are surveyed based on the initial item preference data to generate third item preference data. The new respondent's preference drivers are computed with the third item preference data. The survey is prepared in the same manner as the survey described above for determining the preference drivers of users. The survey calibrates input from the new respondents with the input from the initial respondents. Each new respondent then rates the additional items, for example relative to the items in the survey questions, generating the second item preference data. A regression analysis based on the second and a third item preference data is performed, in the manner described in the preceding paragraph, to project the most likely item vectors for the additional items. The additional items, and the corresponding most likely item vectors, are then incorporated into the feature matrix.

In a further example, the new respondents are surveyed based on the initial item preference data and the new items to generate the third item preference data. The new respondent's preference drivers are computed with the third item preference data. The survey is prepared in the same manner as the survey described above for determining the preference drivers of users. A regression analysis based on the second item preference data is performed, in the manner described in the preceding paragraph, to project the most likely item vectors for the additional items. The additional items, and the corresponding most likely item vectors, are then incorporated into the feature matrix.

Furthermore, in another embodiment the survey taker is asked to provide supplemental information pertaining to the items. The supplemental information may comprise ratings, rankings or any other information. The user preference vector and the supplemental information have many uses. In one example, the user preference vector and the supplemental information are used to fold-in additional items. In other examples, the user preference vector and the supplemental information are used to make pricing decisions, forecast sales and manage inventories and organize items. The data may also be used to ensure that the sample of respondents is representative of a larger set of respondents exhibiting the defined drivers (i.e. do the respondents exhibit a range of preference vectors? Are there preference vectors that are missing or under represented?).

In a further embodiment of a recommendation system, the system recommends movies or itineraries for movie festivals. At movie festivals (such as Sundance and SXSVV), over 100 movies could be playing at multiple locations. After the first screening of each movie, the audience may be surveyed to obtain rankings and reviews from which the item preference vectors for the movies can be generated. They would also be given a survey as described above to determine their preference vectors. Other moviegoers may be surveyed in the manner described above (by themselves or with a group) and be provided with movie recommendations. The movie recommendations may be paired with planning information. Exemplary planning information includes showing schedules, locations, maps and other information pertaining to the festival to help users to find the best movie to watch right now or to plan the remaining festival time.

Referring once again to the use of the recommendation system to recommend a movie, an exemplary recommendation method starts when a user (or members of a group) takes a quick survey based on a set of multiple choice questions pertaining to movie choices meant to quickly capture the preference vectors of the user(s). Based on the preference vectors and the previously computed item vectors (based on a dense item dataset), movie preference scores are computed. Then, a set of recommendations is produced.

The movie recommendations are affected by whether every respondent has watched every movie. Recommendations can be improved by improving the item dataset so that it is less sparse. As discussed previously, the item dataset may include a “not viewed” field to track whether a respondent viewed a movie. When the respondent completes the initial survey, the respondent can also check the “not viewed” field to indicate he/she has not watched the movie. In one embodiment, the “not viewed” facet is used as an exclusionary pre-filter. By pre-filter it is meant that filtering occurs before computation of the item vectors. The initial responses are pre-filtered on the “not viewed” facet. The filtered dataset is used to compute the item vectors. In another embodiment, the “not viewed” facet is used as an exclusionary post-filter. By post-filter it is meant that filtering occurs after computation of the item vectors. The feature matrix is filtered on the “not viewed” facet. In both filtering embodiments, the “not viewed” movies are not available as survey candidates.

Recommendations can also be improved by increasing the power of the item dataset by removing average movies from the computations. In one embodiment, average movies and movies not viewed by many people are excluded from the pool of movies available as survey candidates, to improve the recommendations. A polarizing movie is a movie that is not rated as average. Typically, a polarizing movie has been rated as highly positive or negative by at least one person. In the present embodiment, a training set is generated to identify polarizing movies that have been watched by many people. To find a suitable set of movies for the training set, a small group of respondents (e.g. 20) are asked to rank their favorite movies of all time (e.g. thousands of movies per respondent). The responses are normalized to a mean of 0 and a standard deviation of 1. The sum of squares of the responses is obtained, and the movies are ranked based on the sum of squares. Highly ranked movies are included in the training set, as they represent highly polarizing movies. Average and not watched movies generate scores near or at the mean and, therefore, are not highly ranked. The training set may comprise, for example, 200 movies. The training set is then used in a survey given to a large number of respondents to generate the item preference data. In other words, the sum of squares analysis is used as an inclusionary pre-filter. The item preference data is then used to generate item vectors and select survey candidates, as described above.

Recommendations can also be improved by excluding from the user survey movies that the user has not watched and movies the user probably has not watched. If the survey presents many movies the user has not watched, the user has to switch the movie choices, and the user experience degrades due to the extra steps needed to complete the user survey and the consequent loss of time. In one embodiment, as a user takes a user survey, the system tags the movies switched out, which represent the movies the user has not watched. In a subsequent user survey, the tagged movies are excluded from the survey. The user may also indicate, after taking a survey, that he/she has watched one of the recommended movies. The user may do so, for example, by ordering the movie from a movie delivery service. Alternatively, an icon may be presented by the GUI to enable such indication by the user. The system then tags the movie as a watched movie. The system thus improves the user experience and the recommendations as the user takes more surveys or provides more feedback.

In another embodiment, the user's indication that he/she has or has not watched a movie is used to identify user survey candidates based on a likelihood computation. In one example, the training set described above is developed. Then, all movies that have been watched by the user receive a positive 1 and the movies that have not been watched receive a negative 1. The watched and not watched attributes are added to a “watched” driver added to the item preference data. The dimensionality of the modified training set is then reduced, for example by performing a principal component analysis. The PCA drivers sort movies into groupings, where movies in groups are likely to have been watched or not been watched by the user. The PCA drivers thus comprise a user's “likely watched” vector. An average of two or more vectors corresponding to watched movies is calculated and the average vector is multiplied by the vectors of the items to compute likely watched scores. The movies with the highest scores are the most likely watched movies. The PCA “likely watched” computation may be updated as the survey is being taken so that each subsequent question incorporates the information received from the previous questions. Similarly, the PCA likely watched vectors may be computed while the preference vector is computed, which computation may be repeated after each survey answer is received by the system. The likely watched vector is then used to select survey candidates for subsequent questions. Question candidates are selected from pools of potential candidates excluding items identified as not watched and including items identified as likely watched based on the likely watched vectors. For example, one likely watched driver might be movie vintage, where positive values relate to older movies and negative values relate to newer movies. When a user switches out an older movie, subsequent questions may include movies whose likely watched vectors have large negative values for the vintage driver.

The likely watched vector is fairly stable over time since it is not impacted by current mood. In another embodiment, the likely watched vectors from preceding surveys are recorded and then combined with the watched indications from the user to further improve the selection of survey candidates. In a variation of the present embodiment, a user is provided a “watched” survey from which the likely watched vector is computed. The survey may include, for example, 200 movies. The survey enables the user to identify movies watched and not watched. The likely watched vector may identify that the user is more likely to have watched older movies that are block busters and less likely to have watched movies that are not horror movies. Then, if while taking the short user survey the user switches out an older movie, the likely watched vector is recalculated to incorporate this information, which may remove the bias toward only including older movies in subsequent survey questions. The new information is incorporated by computing the weighted average of the likely watched vector with the vector of the switched out movie. A negative weight is applied to convert the likely watched vector to a likely not watched vector. A higher weight is given to the likely not watched vector computed based on the watched survey since the watched survey includes more information than the small user survey. The weighted likely not watched vector is multiplied by the attributes of any movie to forecast the likelihood that the user has not watched that movie.

The movie recommendation system also recommends new releases. However, the item preference data does not include new release ratings as soon as a new movie is released. In one embodiment, recommendations are improved to include new releases by folding-in new releases and, potentially, new respondents. In the present embodiment, individuals who have watched the newly released movie take a quick survey configured to determine the relative rating of the new release. If an individual is not a respondent, the survey is also configured to determine the individual's preference vector. The user survey is then conducted using the improved item preference data as described above.

Respondent and group characteristics can be used to improve the recommendations by matching or neutralizing biases. Recommendations may be imbalanced if the item preference data is biased based on a characteristic of the respondents, for example. Also, the item vectors may indicate imbalance if one of the principal components is highly correlated to a characteristic of the respondents. For example, if the item preference data includes a disproportionate number of male respondents, or the male respondents disproportionately prefer a subset of movies, as indicated by correlation with a principal component, then the recommendation system may produce recommendations biased towards the subset of male preferred movies.

In one embodiment of a method for making group recommendations, the characteristics of the group are matched to the characteristics of the item preference data. In one example, where the group comprises an even number of users exhibiting a characteristic (e.g. male and female gender), the recommendation method comprises pre-filtering excess respondents exhibiting the biasing characteristic so that the item preference data used to generate the recommendation includes an even number of respondents relative to the characteristic (e.g. equal number of male and female respondents). If a principal component indicates bias, the excess respondents may be selected from the subset of respondents exhibiting the biasing characteristic so as to neutralize the biasing effect. For example, the male respondents highly correlated to the biased principal component may be selected as the excess respondents and filtered out of the item preference data. Any user characteristic may be chosen as the matching, or balancing, characteristic. Exemplary user characteristics include age, gender, sexual bias, profession, hobby, political affiliation, and any other characteristic which can be used to filter respondents. In one variation, the users may indicate that they do not wish to balance the recommendations. In another variation, the users may indicate a balancing characteristic. An example of a screen for selecting a balancing characteristic corresponding to who will watch the movie is described with reference to FIG. 12.

In another example, where the group comprises a majority of users exhibiting a characteristic, for example, the recommendation method comprises pre-filtering excess respondents not exhibiting the characteristic so that the item preference data includes only respondents exhibiting the characteristic. Any user characteristic may be chosen as the inclusion characteristic. Exemplary user characteristics include age, gender, sexual bias, profession, hobby, political affiliation, and any other characteristic which can be used to filter respondents. In one variation, the users may indicate that they do not wish to bias the recommendations. In another variation, the users may indicate the inclusion characteristic.

The embodiments described above in connection with movie recommendations are also applicable to television shows. Furthermore, the embodiments can be further improved to take advantage of differences between movies and television show series. A television show series comprises seasons. Each season includes a plurality of episodes. In one embodiment, an item preference data is comprised of respondents' survey data corresponding to, for example, an overall rating for the series, a season rating for each season, and an episode rating for each or selected episodes. The episode rating may be in relation to other episodes in the season or the series. The information may be used to determine if the show is improving. For example, preceding and succeeding episodes may be compared to determine an improving or worsening trend. The rating for the season may be computed as the average of the episode's ratings. In another embodiment, respondents indicate whether an episode may be enjoyed before watching preceding episodes. If a user seeks a show series recommendation, the recommendation system may recommend a series and also a highly rated episode in the series based on the ratings and the indication whether the episode can be enjoyed without watching the preceding episodes first. The recommendation system may additionally recommend the pilot episode of the show series. In a further embodiment, if the rating of a recommended series decreases compared to previous seasons, the recommendation system provides an indication of the decrease to the user and recommends another series. The item preference data may be updated from time to time with data from supplementary surveys as new episodes become available, in the manner described with reference to new movie releases.

The effect of recommendations may improve if the users trust the recommendation system. User trust may increase if the recommendation system provides to the user additional information. For example, the recommendation system may provide information describing how the recommendations were made or providing reviews from other users. The more affine the descriptions are, the more trust that can be earned. In one embodiment, the preferences of the user are used to provide recommendation information. The preference vectors of respondents or users writing reviews are first evaluated for commonality. Based on the preference vectors, the respondents are grouped. For example, a first group may include individuals whose preference drivers are +1, ±0, −1, −1 indicating a positive driver 1, neutral driver 2, and negative drivers 3 and 4. A second group may include individuals whose preference drivers are −1, ±0, −1, −1 indicating a negative driver 1, neutral driver 2, and negative drivers 3 and 4. In one variation, the user's preference driver is matched with the group exhibiting similar preferences, and the reviews from the matched group are provided to the user. For example, if the user has a positive driver 1, then reviews from the first group are presented. In another variation, the reviewers can be ranked based on the individual's preference vector to find the reviewer with the most similar preference vector. The highest recommended reviews will be presented to the user.

In one variation, the recommendation system provides a review summary reflecting common themes. Key term frequencies may be utilized to summarize the reviews from the group's members. For example, “excellent” may be used to describe the recommendation if the word is used more frequently than the word “good” in the reviews from the group's members. In another variation, in which a recommendation is made to a group of users, the reviews are tailored to each member of the user's group based on the member's preference vector.

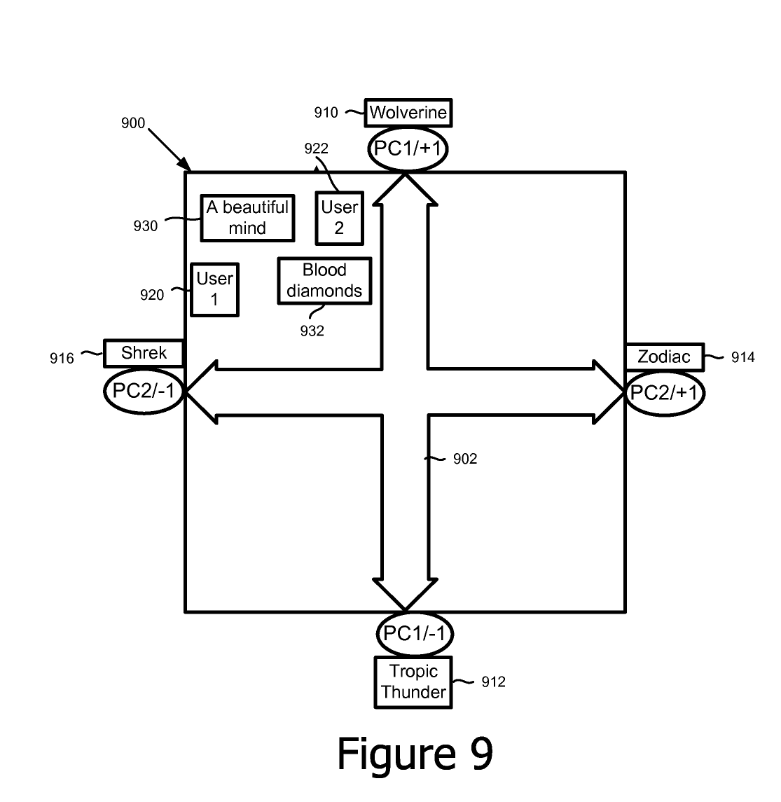

In another embodiment, the recommendation information comprises a visual representation. Referring to FIG. 9, an exemplary visual representation 900 includes a two-dimensional axis graphic 902. Graphic 902 divides the visual representation into four quadrants. Item representations 910, 912, 914 and 916, corresponding to positive and negative attributes of two preference drivers, are shown at each of the four points. In the case where the items are movies, the item representations are the movies from the user survey that represent the opposite values of the first two drivers, e.g. movies having vectors [+1, 0, 0, 0], [−1, 0, 0, 0], [0, +1, 0, 0] and [0, −1, 0, 0] (or as closed to such vectors as possible). These movies describe the range of preference in the first two dimensions. In the present example, these movies are Wolverine, Present Thunder, Zodiac and Shrek. The values of the first two user preference drivers for two users of a group are represented by images 920 and 922 located at the intersection of the values. Based on the location of images 920 and 922, the user preference driver attributes are positive for the first driver and negative for the second driver. Images 930 and 932, representing the top two movie recommendations, A Beautiful Mind and Blood Diamond, are also shown. Their locations of images 930 and 932 in the visual representation are determined in the same manner as the locations of by images 920 and 922 are determined. Additional images may be shown, such as the survey candidate movies and additional recommendations. The visual recommendation information may help users to better understand the range of options and how the recommendations fit within the range, thereby instilling trust in the recommendation system.

In one variation, the axis of the graph is determined using PCA to explain the most variation. For example, to represent drivers in four dimensions with a two-dimensional graph, a PCA is run on all of the points and the two most important drivers (2 newly calculated principal components based on the original four principal components) are plotted to explain the multi-dimensionality of the survey responses. For, instance the second driver may be movies geared toward males versus geared toward females. If two males take the survey together and both are positive driver 2, running the second principal component analysis on their responses will not identify the 2^{nd} driver as important and will exclude that driver in the second principal component analysis. In one example, the points are the set of survey item vectors, the recommended movie vectors, and the user preference vectors. The recommended items and users are also plotted for the same reasons described above. In one example, the user vectors are weighed so that they drive the dimensions of the graph more. Weighing is accomplished by including the user vector multiple times in the data set before the PCA is run.

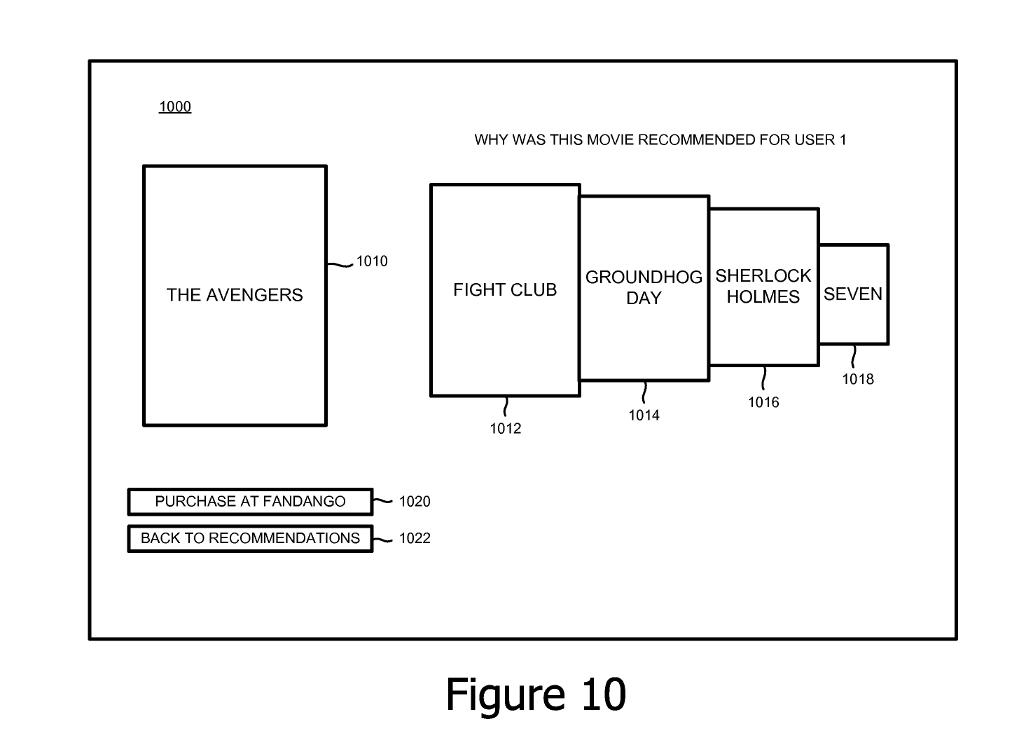

In another variation, images representing the responses from the user survey, or a number of them, are presented scaled proportionately to the similarity of the response to the recommended item. For example, the cosine similarity may be used to determine the scale of each images. Referring to FIG. 10, a representation 1000 of a GUI window is shown illustrating, on the left side, an image 1010 of a recommended movie (The avengers). On the right side, images 1012, 1014, 1016 and 1018 are shown, each being smaller than image 1010. The sizes of the four images are proportional to the similarity of each of the four movies to the recommended movie. In another variation, the four images shown can be arranged differently, for instance as a pie chart. A transaction object 1020 and a navigation object 1022 also shown. A user can activate transaction object 1020 on the GUI window to order delivery of the recommended item. In the present example, the item is a movie and transaction object 1020 is a link to an online vendor where the user can order the movie. If the user orders the movie, the online vendor may compensate the system for making the recommendation. In a variation of the present example, the user selects the delivery service, which is used as a facet for filtering. Facet filtering enables the system to recommend movies to the user that are presently available for delivery by the online vendor while excluding movies that are not available. As described below, inclusive or exclusive filtering is performed. Movie rating is another facet which users may use to limit the recommendations. The user may activate navigation object 1022 to return to the previous webpage or window.

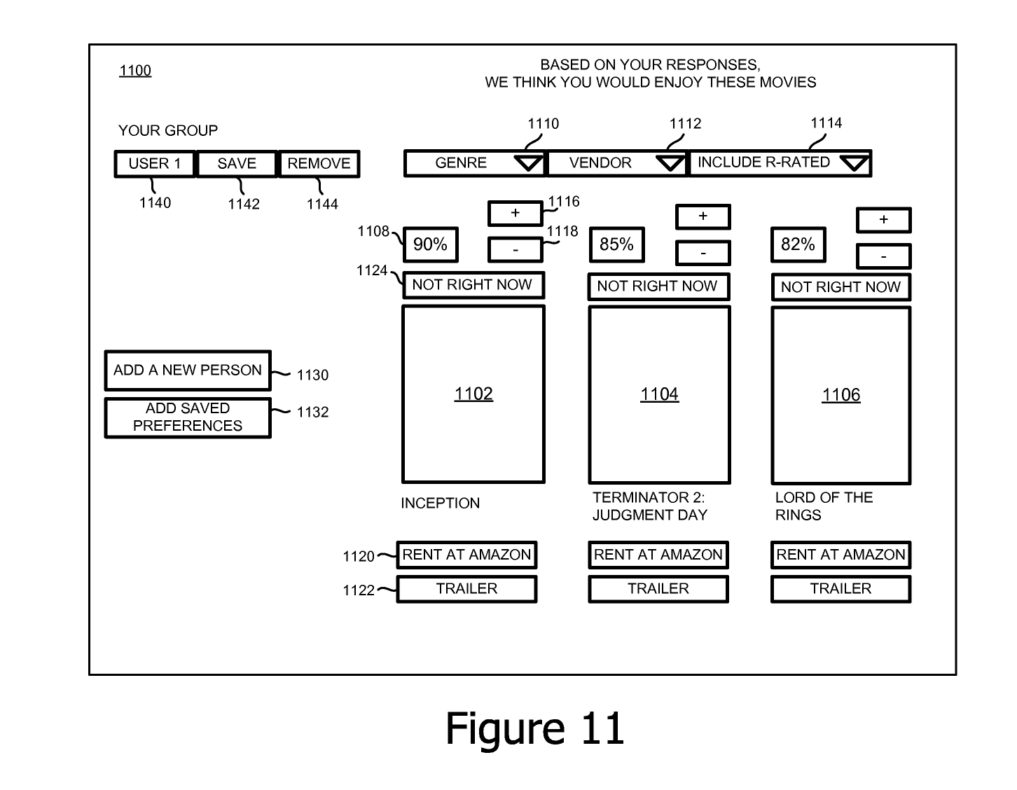

FIG. 11 shows a graphical representation 1100 of a GUI window presented by the recommendation system. The GUI window is configured to provide recommendation information and make the system easy to use. Images 1102, 1104 and 1106 representing recommended items ordered according to their scores. An object 1124 is shown above each image. The user can activate object 1124 to indicate to the recommendation that the user is not in the mood at the present time to select the item. An information box 1108 is shown above each item to show a rating indicative of how well the item scored relative to other items. Below each image are transaction objects 1120 and navigation objects 1122. As before, the user can activate a transaction object 1120 to order the item from an online vendor. If the items are movies, the user can activate a navigation object 1122 to view a trailer of the movie. Above the item images are post-survey facet selection objects 1110, 1112 and 1114, which the user may activate to filter items and change the recommendation. Genre, vendor and “include R-rated” facets are shown. The recommendations may be based on the availability of movies by the chosen vendor. For example, the user may choose Amazon.com as the online vendor. The system may then determine which movies Amazon.com can deliver and only recommend movies from the available movies. Images 1120 may be changed based on the vendor selection.

A recommendation can be viewed as a forecast of the user's actual preferences. The difference, or error, between the forecasted preference and the actual preference may be referred to as the “idiosyncratic” preference for the item for that user. The idiosyncratic preference may reflect the difference between how the user perceives the quality of the movie and the feelings evoked by the movie, which may be based on the circumstances at the time the user last watched the movie. FIG. 11 shows objects 1116 and 1118, which the user may activate to provide feedback to the system reflecting the idiosyncratic preference for the item. The user may activate one object to indicate that the system overrated the movie and the other to indicate that the system underrated the movie. In one example, the score of the item is weighed down by a predetermined amount each time the user indicates the movie is overrated. The score is weighed up if the movie has been underrated. The recommendation system may record the feedback and the idiosyncratic adjustment of the item and adjust the score accordingly when making subsequent recommendations. This adjustment can be absolute (e.g. subtract 5 points off the rating on a 100 point scale) or multiplicative (e.g. reduce the score by 20%). The adjustment may be constrained to ensure no scores exceed 100 or fall below 0. As the user continues to provide feedback over time, the idiosyncratic adjustments can stack.

In one variation, the recommendation system determines that the feedback reflects a different mood based on the amount of feedback. For example, the system may determine a mood shift if the user adjust 3 out of 6 recommended movies. In that case, the recommendation system may recalculate the user preference vector based on the additional data and then recalculate the scores and update the recommendation. A multivariate regression may be run against the drivers expressed by the movies using the idiosyncratic adjustment to determine the new user preference vector.

Another way to collect information about the user is for the user to rank a large set of movies. This can be done by repeatedly asking the user to choose a favorite among two movies to build a list of movies in rank order. This is the actual ranking. The average of the least liked movies can be subtracted from the average of the most liked movies to calculate a user preference vector. The user preference vector may then be used to estimate the expected ranking of each movie based on the score. The difference between the expected and the actual ranking for a movie is the idiosyncratic rating for the movie. In the future, the idiosyncratic rating can be used to adjust future expected rankings even if the user's mood has changed.

In one example, the list of ranked movies is started with the user survey results. Based on the resulting user preference vector, the ranking of each of the twenty-four movies from the six-question survey can be estimated. Then, question-by-question, the user can confirm that the chosen movie is at least as highly rated as the unchosen movies. In other words, to confirm that the chosen movie ranks higher than the unchosen movies from the same question. If this is not true, the ranking of the chosen movie is increased in the ranking list to be above the highest unchosen movie from the same question.

The idiosyncratic preferences can also be used to check if the user has a strong opinion on lower importance drivers (PC5, PC6, etc. . . . ), which are not part of the survey. The average PC5 value for movies that are overrated are subtracted from the average PC5 value for movies that are underrated to determine the users' view of PC5. If so, the PC5 driver can be implied and applied in the user's recommendation calculations, even though the PC5 driver was not included in the user survey. Additional preference drivers may be implied in the same manner.

In another embodiment of the recommendation method, a user can name and save his/her responses as a “mood.” Subsequently, the user can choose a saved mood instead of taking another survey. The user may also name and save the preferences of one or more friends. When seeking a group recommendation, each user may take a survey or choose a saved mood. Alternatively, the user may link his/her account with friends' accounts so that all of the friends' saved moods can be added to a group for determining group recommendations. FIG. 11 also shows a number of group and other objects configured to manage group membership. Item 1140 shows the responses of user 1. When there are more than one user, then each user's name and responses will be shown. Item 1142 allows the user to save the responses and to name the preference as a mood of the user or as a friend of the user. Item 1144 allows the user to remove his or her information from the group. When removed, the recommendations are recalculated based on the remaining users in the group.

In another embodiment of the recommendation method, the user's saved moods are used to target advertisements to the user. The advertisements may be targeted by the recommendation system or by external systems (i.e. advertisements on other websites, emails and direct mailings). The advertisements may be directly related to the recommended items (i.e. data from a movie recommendation used to determine movie advertisements to show the user). The advertisements may also be inferred from the recommended items (i.e. data from a movie recommendation used to infer TV show advertisements). If the user has several moods saved, the advertisements can be based on an average of the moods, on the mood most often used by the user or on the most recently used mood. Note the moods of the user have been saved separately from moods of the friends. Alternatively, multiple advertisements can be shown, each corresponding to each of the moods. Alternatively, one mood can be chosen at random from the set of moods. The odds of a particular mood being chosen (for the purpose of selecting an ad) is proportional to the frequency that mood is chosen by the user. (i.e. the user has moods A and B, exhibits mood A 90% of the time and mood B 10% of the time. Advertisements corresponding to mood A will therefore be shown more frequently).

Furthermore, in another embodiment of the recommendation method, a user preference vector is compiled based on user inputs without a survey. The user inputs one movie or a list of movies. The user preference vector is computed as the average of the vectors corresponding to the inputted movie(s).

FIG. 12 shows a graphical representation 1200 of a GUI window presented by the recommendation system to filter items before a survey is taken. The GUI window displays objects 1210, 1212, 1214 and 1216 corresponding to different pre-survey filter criteria. In the present example, items are movies. The user may activate object 1210 if the user wishes to watch a movie alone, object 1212 if a couple will watch the movie, object 1214 if a family will watch the movie, and object 1216 if a group of friends will watch the movie. Each object has an associated filter profile. For example, the family filter may exclude R-rated movies while the couple filter may exclude violent movies but include movies rated R due to nudity or sexual language. The filters may be pre-defined in the system according to the type of items being recommended. The user survey is then administered based on the filters selected by the user. Using the filters, the user can quickly and effectively exclude from the survey certain items based on content. The filtered items do not appear in the user survey and, therefore, the user does not have to switch them out during the survey. An object 1220 is provided to enable the user to receive recommendations based on a previous survey taken by the user.

FIG. 13 shows a graphical representation 1300 of a GUI window presented by a recommendation system configured to give a user the option to take different surveys, which may be referred to as “quizzes” or “quiz.” As shown in FIG. 13, the GUI window displays images 1310-1315 to show the user the types of items available within a category and objects 1320-1325 to show the types of items available within another category. The GUI window includes objects 1302 and 1304, which the user may activate to select one or the other category. In one example, the items are movies, and the user may choose between a quiz with older movies (e.g. 1009-2005) and a quiz with newer movies (e.g. 2005-2010). In another example, the user may be asked his/her age and the recommendation system then infers a quiz choice. The movie drivers and questions for each quiz are calibrated using separate training sets.

As used herein, an application, algorithm or, processing sequence, is a self consistent sequence of instructions that can be followed to perform a particular task. Computer software, or software, executes an algorithm and can be divided into application software, or application, and systems software. An application executes instructions for an end-user, or user, where systems software consists of low-level programs that operate between an application and hardware. Systems software includes operating systems, compilers, and utilities for managing computer resources. While computing systems typically include systems software and applications software, they may also operate with software that encompasses both application and systems functionality. Applications may use data structures for both inputting information and performing the particular task. Data structures greatly facilitate data management. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

As used herein, a computing device may be a specifically constructed apparatus or may comprise general purpose computers selectively activated or reconfigured by software stored therein. The computing device, whether specifically constructed or general purpose, has at least one processor, or processing device, for executing machine instructions, which may be grouped in processing sequences, and access to memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Exemplary computing devices include workstations, personal computers, portable computers, portable wireless devices, mobile devices, and any device including a processor, memory and software. Computing systems encompass one or more computing devices and include computer networks and distributed computing devices.

As used herein, a computer network, or network, is a system of computers or computing devices interconnected in such a manner that messages may be transmitted between them. Typically one or more computers operate as a “server”, a computer with access to large storage devices such as hard disk drives and communication hardware to operate peripheral devices such as printers, routers, or modems. Other computers, termed “workstations”, provide a user interface so that users of computer networks can access the network resources, such as shared data files, common peripheral devices, and inter workstation communication.

As used herein, portable wireless devices include mobile phones, personal digital assistants, tablets, laptop computers, and any other portable devices with wireless connectivity.

Embodiments of the disclosure may be implemented in “object oriented” software. The “object oriented” software is organized into “objects”, each comprising a block of computer instructions describing various procedures to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a mouse pointer or touch-screen to generate an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access.

As used herein, the transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

Information elicitation and recommendation methods and systems have been described for eliciting information from users and for recommending items to users based on the elicited information. According to embodiments of the method, item preference data, initially obtained from respondents, is analyzed to identify pseudo-independent items. The pseudo-independent items are used to administer a survey to one or more users. The user's responses define the user's preference drivers. Recommendation items are identified based on the user's preference drivers. The identified items are presented to the user(s). User can also switch-out items presented in the survey questions if they are unfamiliar with the items. The switch-out information can be used to better select questions for the same user in the future so as to not ask redundant questions that degrade the user experience. The foregoing functions are implemented with processing sequences embedded in memory. Some or all of the processing sequences may be embedded in the memory of a system according to one embodiment of the disclosure. Some of the processing sequences may be imbedded in a memory of a user device operable to administer the survey and present the recommendations. Of course, the functions implemented by the processing sequences may be distributed in different arrangements defining variations of the foregoing system embodiments without departing from the teaching of the disclosure. Several embodiments and examples were described with reference to movies for illustration purposes. However, the concepts illustrated by the embodiments and examples are also applicable to any items. Exemplary items include clothing, jewelry, electronics, food items etc.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method of promotion based on information elicited from a user, the method comprising:
by a processing device processing instructions embedded in one or more non-transitory computer readable medium:
reducing the dimensionality of item preference data corresponding to items and identifying pseudo-independent items, from the items, based on the reduced dimensionality item preference data;
determining a set of multiple choice questions based on the pseudo-independent items, each of the questions including at least two pseudo-independent items configured to elicit a response from the user;
outputting information for presenting the set of multiple choice questions;
receiving responses to the set of multiple choice questions, each of the responses comprising an item selection representing explicit pseudo independent items relative information; and
composing a user preference vector based on the responses.

2. A method as in claim 1, wherein the outputting and the receiving are performed by processing application programming interface (API) instructions.

3. A method as in claim 1, further comprising, by a user device application, presenting the questions and outputting the responses.

4. A method as in claim 1, further comprising generating second item preference data for additional items and performing a regression computation based on the second item preference data to fold-in the additional items into the item preference data.

5. A method as in claim 1, further comprising outputting an item recommendation based on the user preference vector.

6. A method as in claim 1, further comprising outputting the information to elicit the explicit pseudo independent items relative information from users in a group, and outputting an item recommendation based on the responses from the users in the group.

7. A method as in claim 1, further comprising receiving item reviews from reviewers, identifying from the reviewers those reviewers whose preferences are similar to the user's preferences, and outputting an item recommendation including a recommended item and the item reviews received from the identified reviewers and relating to the recommended item.

8. A method as in claim 1, wherein the item preference data comprises preference data from respondents and a content driver, wherein dimensionality reduction has a content discriminating effect on the pseudo-independent items due to the content driver.

9. A method as in claim 8, wherein items are movies and the content driver reflects whether the user has watched the movies, the discriminating effect discriminates likely watched movies from likely not watched movies, such that the questions will relate to more likely watched movies than if the content driver were not included in the item preference data.

10. A method as in claim 1, wherein reducing the dimensionality of the item preference data generates item preference vectors corresponding to the items, and the method further comprises generating increased dimensionality item preference vectors by appending a content driver to the item preference vectors.

11. A method as in claim 10, wherein the items are movies, and the content driver includes a genre selected from the group comprising one or more of action, drama, comedy, horror/thriller, romance, and animated, wherein the content driver discriminates the items based on the genre.

12. A method as in claim 1, further comprising calculating item scores for the items, outputting an item recommendation including a recommended item and a preference value indicative of a predicted preference strength of the user for the recommended item, the item recommendation and the preference value based on the item scores, receiving an idiosyncratic feedback from the user indicative of the user's actual preference strength, and adjusting a future item score of the recommended item by an idiosyncratic amount related to the idiosyncratic feedback.

13. A method as in claim 1, wherein the questions configured to elicit explicit pseudo independent items relative information from the user are operable to determine a user preference vector, further comprising outputting idiosyncratic questions configured to elicit idiosyncratic preferences.

14. A method as in claim 1, further comprising saving the responses in a preference profile; and outputting advertisements for the user based on the preference profile.

15. A system for promotion based on information elicited from a user, the system comprising:
a processing device;
a non-transitory computer readable medium;
processing instructions embedded in the non-transitory computer readable medium, the processing instructions configured to elicit information from the user when processed by the processing device, the processing instructions including:
first processing instructions structured to reduce the dimensionality of item preference data corresponding to items and identifying pseudo-independent items, from the items, based on the reduced dimensionality item preference data;
second processing instructions structured to determine a set of multiple choice questions based on the pseudo-independent items, each of the questions including at least two pseudo-independent items configured to elicit a response from the user;
third processing instructions structured to output information for presenting questions and to receive responses, the questions based on the pseudo-independent items to elicit explicit pseudo independent items relative information from the user; and
fourth processing instructions structured to compose a user preference vector based on the responses.

16. A system as in claim 15, wherein each of the questions includes at least two pseudo-independent items and each of the responses includes an item selection.

17. A system as in claim 15, further comprising an application programming interface (API) including the third processing instructions.

18. A system as in claim 15, the processing instructions further including fifth processing instructions structured to generate second item preference data for additional items and performing a regression computation based on the second item preference data to fold-in the additional items into the item preference data.

19. A system as in claim 15, wherein the first processing instructions are further configured for composing a user preference vector based on the responses and the third processing instructions are further structured to output an item recommendation based on the user preference vector.

20. A method of promotion based on information elicited from a user, the method comprising:
by a processing device processing instructions embedded in one or more non-transitory computer readable medium:
identifying the user when the user accesses a website;
accessing a user preference profile of the user, the user preference profile based on pseudo independent items relative information previously elicited from the user by reducing the dimensionality of item preference data corresponding to items and identifying pseudo-independent items, from the items, based on the reduced dimensionality item preference data; determining a set of multiple choice questions based on the pseudo-independent items, each of the questions including at least two pseudo-independent items configured to elicit a response from the user; outputting information for presenting the set of multiple choice questions; and receiving responses to the set of multiple choice questions, each of the responses comprising an item selection representing explicit pseudo independent items relative information; and composing a user preference profile based on the responses;
identifying preferred items based on item preference vectors and the user preference profile; and
serving advertisements relating to the preferred items.
